(19) United States
(12) Patent Application Publication
(10) Pub. No.: US 2025/0203619 A1
(43) Pub. Date: Jun. 19, 2025

(54) METHOD AND APPARATUS FOR TRANSFORM PRECODING STATE SWITCHING FOR A PUSCH

(71) Applicant: Lenovo (Beijing) Limited, Beijing (CN)

(72) Inventors: Ruixiang Ma, Beijing (CN); Yuantao Zhang, Beijing (CN); Hongmei Liu, Beijing (CN); Zhi Yan, Beijing (CN); Haiming Wang, Beijing (CN)

(73) Assignee: Lenovo (Beijing) Limited, Beijing (CN)

(21) Appl. No.: 18/845,691

(22) PCT Filed: Mar. 11, 2022
(86) PCT No.: PCT/CN2022/080369

§ 371 Date: Sep. 10, 2024

(51) Int. Cl. H04W 72/21; H04B 7/0456; H04W 72/0446

(52) U.S. Cl. CPC H04W 72/21; H04B 7/0456; H04W 72/0446

(57) ABSTRACT

Embodiments of the present disclosure relate to method and apparatus for transform precoding state switching for a physical uplink shared channel (PUSCH). According to some embodiments of the disclosure, a UE may include: a transceiver configured to: receive first indication information indicating a transform precoding state for a PUSCH transmission, wherein the transform precoding state indicates whether a transform precoding is enabled or not; and a processor coupled to the transceiver and configured to: determine whether to apply the transform precoding state to a first PUSCH transmission.

### TECHNICAL FIELD

Embodiments of the present disclosure generally relate to wireless communication technology, and more particularly to transform precoding state switching for a physical uplink shared channel (PUSCH).

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In a wireless communication system, a user equipment (UE) may transmit data signals to a base station (BS) via a PUSCH. Various waveforms, including for example, a discrete Fourier transform-spread orthogonal frequency division multiplexing (DFT-s-OFDM) waveform and a cyclic prefix orthogonal frequency division multiplexing (CP-OFDM) waveform, may be applied to a PUSCH transmission. Different waveforms may be advantageous in different scenarios. However, how to dynamically switch between different waveforms to facilitate the advantages of different waveforms in different scenarios has not been discussed yet.

### SUMMARY

Some embodiments of the present disclosure provide a UE. The UE may include: a transceiver configured to: receive first indication information indicating a transform precoding state for a PUSCH, wherein the transform precoding state indicates whether a transform precoding is enabled or not; and a processor coupled to the transceiver and configured to: determine whether to apply the transform precoding state to a first PUSCH transmission.

In some embodiments of the present application, the first indication information comprises downlink control information (DCI), and the transceiver is further configured to receive configuration information indicating whether a field for indicating the transform precoding state exists or not in the DCI.

In some embodiments of the present application, the first indication information indicates whether the transform precoding is enabled or not directly, indicates that the transform precoding state is switched from one of an enabled state and a disabled state to the other state of the enabled state and disabled state, or indicates that the transform precoding state is switched from a default transform precoding state to another state.

In some embodiments of the present application, in the case that the configuration information indicates that the field does not exist, the transform precoding state is a default transform precoding state.

In some embodiments of the present application, the configuration information is configured per UE or per DCI format. In some embodiments of the present application, the first indication information comprises DCI, and the transceiver is further configured to receive configuration information indicating a set of elements, each element is associated with one or more transform precoding states, and the DCI indicates one of the set of elements.

In some embodiments of the present application, the DCI indicates a first transform precoding state and a second transform precoding state, and: in the case that a number of repetitions of the first PUSCH transmission is two, the first transform precoding state is indicated to be applied to a first repetition of the number of repetitions and the second transform precoding state is indicated to be applied to a second repetition of the number of repetitions; in the case that the number of repetitions of the first PUSCH transmission is larger than two and a cyclic mapping is enabled, the first transform precoding state and the second transform precoding state are indicated to be applied to a first and a second repetitions of the number of repetitions respectively, and the same mapping pattern continues to the remaining repetitions of the number of repetitions; and in the case that a number of repetitions of the first PUSCH transmission is larger than two and a sequential mapping is enabled, the first transform precoding state is indicated to be applied to a first repetition and a second repetition of the number of repetitions, and the second state of transform precoding is indicated to be applied to a third repetition and a fourth repetition of the number of repetitions, and the same mapping pattern continues to the remaining repetitions of the number of repetitions.

In some embodiments of the present application, the first indication information comprises DCI, and the DCI comprises a time domain resource allocation (TDRA) field, which indicates a number of repetitions of the first PUSCH transmission: in the case that the number of repetitions is larger than a threshold, a first transform precoding state is indicated to be applied to the first PUSCH transmission; and in the case that the number of repetitions is small than or equal to the threshold, a second transform precoding state is indicated to be applied to the first PUSCH transmission, wherein the threshold is configured by a network or is pre-defined.

In some embodiments of the present application, the first indication information comprises a DCI, and the DCI includes a TDRA field, which indicates a row in a table, wherein the row indicates at least one of: a slot offset; a start and length indicator (SLIV), or a start symbol and an allocation length; a PUSCH mapping type; a transform precoding state for a PUSCH transmission; or a number of repetitions to be applied to a PUSCH transmission.

In some embodiments of the present application, in the case that the row does not indicate a transform precoding state, the transform precoding state for the first PUSCH transmission is a default transform precoding state.

In some embodiments of the present application, the first indication information comprises a DCI, and the DCI comprises a frequency domain resource allocation (FDRA) field; wherein a first value of the FDRA field indicates a first resource allocation type and a second value of the FDRA field indicates a second resource allocation type; and wherein in the case that the first resource allocation type is indicated, the transform precoding is disabled, and in the case that the second resource allocation type is indicated, the transform precoding is enabled.

In some embodiments of the present application, a first value is 0 and the second value is 1, and wherein the first resource allocation type is resource allocation type 0 and the second resource allocation type is resource allocation type 1.

In some embodiments of the present application, the first indication information comprises a DCI, and the transceiver is further configured to receive configuration information indicating that a first sounding reference signal (SRS) resource set is associated with a first transform precoding state and a second SRS resource set is associated with a second transform precoding state, and the DCI comprises a SRS resource indicator which indicates a SRS resource set(s) for the first PUSCH transmission.

In some embodiments of the present application, in the case that a number of repetitions of the first PUSCH transmission is larger than one and the SRS resource indicator indicates a first value, the first transform precoding state is indicated to be applied to all of the number of repetitions; in the case that the number of repetitions of the first PUSCH transmission is larger than one and the SRS resource indicator indicates a second value, the second transform precoding state is indicated to be applied to all of the number of repetitions; in the case that the SRS resource indicator indicates a third value: in the case that the number of repetitions of the first PUSCH transmission is two, the first transform precoding state is indicated to be applied to a first repetition of the number of repetitions and the second transform precoding state is indicated to be applied to a second repetition of the number of repetitions; in the case that the number of repetitions of the first PUSCH transmission is larger than two and a cyclic mapping is enabled, the first transform precoding state and the second transform precoding state are indicated to be applied to first and second repetitions of the number of repetitions, respectively, and the same mapping pattern continues to the remaining repetitions; and in the case that the number of repetitions of the first PUSCH transmission is larger than two and a sequential mapping is enabled, the first transform precoding state is indicated to be applied to a first repetition and a second repetition of the number of repetitions, and the second transform precoding state is indicated to be applied to a third repetition and a fourth repetition of the number of repetitions, and the same mapping pattern continues to the remaining repetitions.

In some embodiments of the present application, the first indication information comprises DCI, and wherein the transform precoding state is indicated by a DCI format of the DCI, or wherein the transform precoding state is indicated by a search space set, a control resource set (CORESET), or a bandwidth part (BWP) in which the DCI is received.

In some embodiments of the present application, in the case that the DCI format of the DCI is a fallback DCI format, a default transform precoding state is indicated.

In some embodiments of the present application, the transceiver is further configured to receive configuration information indicating an association between a DCI format and a transform precoding state, or the association between a DCI format and a transform precoding state is pre-defined; or wherein the transceiver is further configured to receive configuration information indicating an association between the search space set, the CORESET, or the BWP in which the DCI is received and a transform precoding state, or the association between the search space set, the CORESET, or the BWP in which the DCI is received and a transform precoding state is pre-defined.

In some embodiments of the present application, first indication information comprises DCI, and a cyclic redundancy check (CRC) of the DCI is scrambled by a radio network temporary identifier (RNTI), and the transform precoding state is indicated by the RNTI.

In some embodiments of the present application, the RNTI is an RNTI specific for transform precoding state switch.

In some embodiments of the present application, determining whether to apply the transform precoding state comprises: determining whether to apply the transform precoding state based on a number of time units between a first time unit associated with the first indication information and a second time unit associated with the first PUSCH transmission.

In some embodiments of the present application, determining whether to apply the transform precoding state comprises: in the case that the number of time units is smaller than a timing parameter for transform precoding state switch, determining not to apply the transform precoding state to the first PUSCH transmission; and in the case that the number of time units is larger than or equal to the timing parameter, determining to apply the transform precoding state to the first PUSCH transmission.

In some embodiments of the present application, the time unit is one of: a frame, a subframe, a slot, a sub-slot, a mini-slot or a symbol.

In some embodiments of the present application, the transceiver is further configured to report the timing parameter; or wherein the timing parameter is pre-defined.

In some embodiments of the present application, the transceiver is further configured to perform at least one of the following: reporting whether the UE supports transform precoding state switch or not; or receiving configuration information indicating whether the UE is allowed to perform transform precoding state switch.

In some embodiments of the present application, the default transform precoding state is determined based on higher layer signaling or is pre-defined.

In some embodiments of the present application, the first PUSCH transmission is one of: a configured grant (CG) type 1 based PUSCH transmission; a CG type 2 based PUSCH transmission; a PUSCH transmission scheduled by a fallback DCI; a PUSCH transmission scheduled by a DCI which is not configured with transform precoding state switch.

Some embodiments of the present disclosure provide a UE. The UE may include a transceiver configured to: a processor; and a transceiver coupled to the processor, wherein the transceiver is configured to: receive first indication information indicating a first transform precoding state, wherein the first transform precoding state indicates whether a transform precoding is enabled or not; and transmit a first PUSCH based on the first transform precoding state.

In some embodiments of the present application, the first transform precoding state is not applied to a PUSCH transmission after the first PUSCH transmission.

In some embodiments of the present application, the first indication information comprises DCI; and wherein the first PUSCH transmission is scheduled by the DCI, or a number of time units between a first time unit associated with the DCI and a second time unit associated with the first PUSCH transmission is larger than or equal to a timing parameter.

In some embodiments of the present application, the processor is further configured to determine whether the first transform precoding is applied to a second PUSCH transmission after the first PUSCH transmission or not.

In some embodiments of the present application, determining whether the first transform precoding is applied to the second PUSCH transmission includes: in the case that a second indication information indicating a second transform precoding state is received after the first indication information but before the second PUSCH transmission, the first transform precoding is not applied to the second PUSCH transmission; otherwise, the first indication information is applied to the second PUSCH transmission; or in the case that the second indication information indicating the second transform precoding state is received after the first indication information and a number of time units between a first time unit associated with the second indication information and a second time unit associated with the second PUSCH transmission is larger than or equal to a timing parameter, the first transform precoding is not applied to the second PUSCH transmission; otherwise, the first transform precoding is applied to the second PUSCH transmission.

In some embodiments of the present application, determining whether the first transform precoding state is applied to the second PUSCH transmission includes: starting a timer in response to receiving the first DCI; determining that the first transform precoding state is applied to the second PUSCH transmission when the timer is running; and determining that the first transform precoding state is not applied to the second PUSCH transmission when the timer expires.

In some embodiments of the present application, a value of the timer is configured by a network or is pre-defined.

In some embodiments of the present application, a value of the timer includes a number of time units, and wherein the time unit is one of: a frame, a subframe, a slot, a sub-slot, a mini-slot or a symbol.

In some embodiments of the present application, the processor is configured to apply a default transform precoding state or a transform precoding state applied before the first transform precoding state to the second PUSCH transmission after the timer expires.

In some embodiments of the present application, the transceiver is further configured to receive second indication information indicating a second transform precoding state when the time is running; and wherein the second transform precoding state is the same as the first transform precoding state, or wherein the second transform precoding state is different from the first transform precoding state and the processor is further configured to perform at least one of the following:

ignore the second transform precoding state; or apply the second transform precoding state for the second PUSCH transmission in response to an expiry of the timer.

In some embodiments of the present application, the timer is started when the first indication information indicates that the transform precoding is switched from an enabled state to a disabled state; the timer is started when the first indication information indicates that the transform precoding is switched from a disabled state to an enabled state; or the processor is further configured to receive configuration information indicating that the timer is started when the first indication information indicates that the transform precoding is switched from one of the enabled state and disabled state to the other of the enabled state and disabled state.

In some embodiments of the present application, the transceiver is further configured to perform at least one of the following: reporting whether the UE supports transform precoding state switch or not; or receiving configuration information indicating whether the UE is allowed to perform transform precoding state switch.

Some embodiments of the present disclosure provide a BS. The BS may include: a transceiver configured to: transmit, to a UE, first indication information indicating a transform precoding state for a PUSCH, wherein the transform precoding state indicates whether a transform precoding is enabled or not; and a processor coupled to the transceiver and configured to: determine whether the transform precoding state is applied to a first PUSCH transmission.

In some embodiments of the present application, the first indication information comprises DCI, and the transceiver is further configured to transmit configuration information indicating whether a field for indicating the transform precoding state exists or not in the DCI.

In some embodiments of the present application, the first indication information indicates whether the transform precoding is enabled or not directly, indicates that the transform precoding state is switched from one of an enabled state and a disabled state to the other state of the enabled state and disabled state, or indicates that the transform precoding state is switched from a default transform precoding state to another state.

In some embodiments of the present application, in the case that the configuration information indicates that the field does not exist, the transform precoding state is a default transform precoding state.

In some embodiments of the present application, the configuration information is configured per UE or per DCI format.

In some embodiments of the present application, the first indication information comprises DCI, and the transceiver is further configured to transmit configuration information indicating a set of elements, each element is associated with one or more transform precoding states, and the DCI indicates one of the set of elements.

In some embodiments of the present application, the DCI indicates a first transform precoding state and a second transform precoding state, and: in the case that a number of repetitions of the first PUSCH transmission is two, the first transform precoding state is indicated to be applied to a first repetition of the number of repetitions and the second transform precoding state is indicated to be applied to a second repetition of the number of repetitions; in the case that the number of repetitions of the first PUSCH transmission is larger than two and a cyclic mapping is enabled, the first transform precoding state and the second transform precoding state are indicated to be applied to a first and a second repetitions of the number of repetitions respectively, and the same mapping pattern continues to the remaining repetitions of the number of repetitions; and in the case that a number of repetitions of the first PUSCH transmission is larger than two and a sequential mapping is enabled, the first transform precoding state is indicated to be applied to a first repetition and a second repetition of the number of repetitions, and the second state of transform precoding is indicated to be applied to a third repetition and a fourth repetition of the number of repetitions, and the same mapping pattern continues to the remaining repetitions of the number of repetitions.

In some embodiments of the present application, the first indication information comprises DCI, and the DCI comprises a TDRA field, which indicates a number of repetitions of the first PUSCH transmission: in the case that the number of repetitions is larger than a threshold, a first transform precoding state is indicated to be applied to the first PUSCH transmission; and in the case that the number of repetitions is small than or equal to the threshold, a second transform precoding state is indicated to be applied to the first PUSCH transmission, wherein the threshold is configured by a network or is pre-defined.

In some embodiments of the present application, the first indication information comprises a DCI, and the DCI includes a TDRA field, which indicates a row in a table, wherein the row indicates at least one of: a slot offset; an SLIV, or a start symbol and an allocation length; a PUSCH mapping type; a transform precoding state for a PUSCH transmission; or a number of repetitions to be applied to a PUSCH transmission.

In some embodiments of the present application, in the case that the row does not indicate a transform precoding state, the transform precoding state for the first PUSCH transmission is a default transform precoding state.

In some embodiments of the present application, the first indication information comprises a DCI, and the DCI comprises a FDRA field; wherein a first value of the FDRA field indicates a first resource allocation type and a second value of the FDRA field indicates a second resource allocation type; and wherein in the case that the first resource allocation type is indicated, the transform precoding is disabled, and in the case that the second resource allocation type is indicated, the transform precoding is enabled.

In some embodiments of the present application, a first value is 0 and the second value is 1, and wherein the first resource allocation type is resource allocation type 0 and the second resource allocation type is resource allocation type 1.

In some embodiments of the present application, the first indication information comprises a DCI, and the transceiver is further configured to transmit configuration information indicating that a first SRS resource set is associated with a first transform precoding state and a second SRS resource set is associated with a second transform precoding state, and the DCI comprises a SRS resource indicator which indicates a SRS resource set(s) for the first PUSCH transmission.

In some embodiments of the present application, in the case that a number of repetitions of the first PUSCH transmission is larger than one and the SRS resource indicator indicates a first value, the first transform precoding state is indicated to be applied to all of the number of repetitions; in the case that the number of repetitions of the first PUSCH transmission is larger than one and the SRS resource indicator indicates a second value, the second transform precoding state is indicated to be applied to all of the number of repetitions; in the case that the SRS resource indicator indicates a third value: in the case that the number of repetitions of the first PUSCH transmission is two, the first transform precoding state is indicated to be applied to a first repetition of the number of repetitions and the second transform precoding state is indicated to be applied to a second repetition of the number of repetitions; in the case that the number of repetitions of the first PUSCH transmission is larger than two and a cyclic mapping is enabled, the first transform precoding state and the second transform precoding state are indicated to be applied to first and second repetitions of the number of repetitions, respectively, and the same mapping pattern continues to the remaining repetitions; and in the case that the number of repetitions of the first PUSCH transmission is larger than two and a sequential mapping is enabled, the first transform precoding state is indicated to be applied to a first repetition and a second repetition of the number of repetitions, and the second transform precoding state is indicated to be applied to a third repetition and a fourth repetition of the number of repetitions, and the same mapping pattern continues to the remaining repetitions.

In some embodiments of the present application, the first indication information comprises DCI, and wherein the transform precoding state is indicated by a DCI format of the DCI, or wherein the transform precoding state is indicated by a search space set, a CORESET, or a BWP in which the DCI is transmitted.

In some embodiments of the present application, in the case that the DCI format of the DCI is a fallback DCI format, a default transform precoding state is indicated.

In some embodiments of the present application, the transceiver is further configured to transmit configuration information indicating an association between a DCI format and a transform precoding state, or the association between a DCI format and a transform precoding state is pre-defined; or the transceiver is further configured to transmit configuration information indicating an association between the search space set, the CORESET, or the BWP in which the DCI is transmitted and a transform precoding state, or the association between the search space set, the CORESET, or the BWP in which the DCI is transmitted and a transform precoding state is pre-defined.

In some embodiments of the present application, first indication information comprises DCI, and a CRC of the DCI is scrambled by an RNTI, and the transform precoding state is indicated by the RNTI.

In some embodiments of the present application, the RNTI is an RNTI specific for transform precoding state switch.

In some embodiments of the present application, determining whether the transform precoding state is applied comprises determining whether the transform precoding state is applied based on a number of time units between a first time unit associated with the first indication information and a second time unit associated with the first PUSCH transmission.

In some embodiments of the present application, determining whether the transform precoding state is applied comprises: in the case that the number of time units is smaller than a timing parameter for transform precoding state switch, determining that the transform precoding state is not applied to the first PUSCH transmission; and in the case that the number of time units is larger than or equal to the timing parameter, determining that the transform precoding state is applied to the first PUSCH transmission.

In some embodiments of the present application, the time unit is one of: a frame, a subframe, a slot, a sub-slot, a mini-slot or a symbol.

In some embodiments of the present application, the transceiver is further configured to receive the timing parameter from the UE, or the timing parameter is pre-defined.

In some embodiments of the present application, the transceiver is further configured to perform at least one of the following: receiving an indication of whether the UE supports transform precoding state switch or not; or transmitting configuration information indicating whether the UE is allowed to perform transform precoding state switch.

In some embodiments of the present application, the processor is further configured to determine the default transform precoding state, or the default transform precoding state is pre-defined.

In some embodiments of the present application, the first PUSCH transmission is one of: a CG type 1 based PUSCH transmission; a CG type 2 based PUSCH transmission; a PUSCH transmission scheduled by a fallback DCI; a PUSCH transmission scheduled by a DCI which is not configured with transform precoding state switch.

Some embodiments of the present disclosure provide a BS. The BS may include: a processor; and a transceiver coupled to the processor, wherein the transceiver is configured to: transmit, to a UE, first indication information indicating a first transform precoding state, wherein the first transform precoding state indicates whether a transform precoding is enabled or not; and receive, from the UE, a first PUSCH based on the first transform precoding state.

In some embodiments of the present application, the first transform precoding state is not applied to a PUSCH transmission after the first PUSCH transmission.

In some embodiments of the present application, the first indication information comprises DCI; and wherein the first PUSCH transmission is scheduled by the DCI, or a number of time units between a first time unit associated with the DCI and a second time unit associated with the first PUSCH transmission is larger than or equal to a timing parameter.

In some embodiments of the present application, the processor is further configured to determine whether the first transform precoding is applied to a second PUSCH transmission after the first PUSCH transmission or not.

In some embodiments of the present application, determining whether the first transform precoding is applied to the second PUSCH transmission includes: in the case that a second indication information indicating a second transform precoding state is transmitted after the first indication information but before the second PUSCH transmission, the first transform precoding is not applied to the second PUSCH transmission; otherwise, the first indication information is applied to the second PUSCH transmission; or in the case that the second indication information indicating the second transform precoding state is transmitted after the first indication information and a number of time units between a first time unit associated with the second indication information and a second time unit associated with the second PUSCH transmission is larger than or equal to a timing parameter, the first transform precoding is not applied to the second PUSCH transmission; otherwise, the first transform precoding is applied to the second PUSCH transmission.

In some embodiments of the present application, determining whether the first transform precoding state is applied to the second PUSCH transmission includes: starting a timer in response to receiving the first DCI; determining that the first transform precoding state is applied to the second PUSCH transmission when the timer is running; and determining that the first transform precoding state is not applied to the second PUSCH transmission when the timer expires.

In some embodiments of the present application, the transceiver is further configured to transmit a value of the timer to the UE, or the value of the timer is pre-defined.

In some embodiments of the present application, a value of the timer includes a number of time units, and wherein the time unit is one of: a frame, a subframe, a slot, a sub-slot, a mini-slot or a symbol.

In some embodiments of the present application, a default transform precoding state or a transform precoding state applied before the first transform precoding state is applied to the second PUSCH transmission after the timer expires.

In some embodiments of the present application, the transceiver is further configured to transmit, to the UE, second indication information indicating a second transform precoding state when the time is running; and wherein the second transform precoding state is the same as the first transform precoding state, or wherein the second transform precoding state is different from the first transform precoding state and the second transform precoding state is indicated to be applied to the second PUSCH transmission in response to the expiry of the timer.

In some embodiments of the present application, the timer is started when the first indication information indicates that the transform precoding is switched from an enabled state to a disabled state; the timer is started when the first indication information indicates that the transform precoding is switched from a disabled state to an enabled state; or the processor is further configured to transmit configuration information indicating that the timer is started when the first indication information indicates that the transform precoding is switched from one of the enabled state and disabled state to the other of the enabled state and disabled state.

In some embodiments of the present application, the transceiver is further configured to perform at least one of the following: receiving an indication of whether the UE supports transform precoding state switch or not; or transmitting configuration information indicating whether the UE is allowed to perform transform precoding state switch.

Some embodiments of the present disclosure provide a method performed by a UE. The method may include: receiving first indication information indicating a transform precoding state for a PUSCH, wherein the transform precoding state indicates whether a transform precoding is enabled or not; and determining whether to apply the transform precoding state to a first PUSCH transmission.

Some embodiments of the present disclosure provide a method performed by a UE. The method may include: receiving first indication information indicating a first transform precoding state, wherein the first transform precoding state indicates whether a transform precoding is enabled or not; and transmitting a first PUSCH based on the first transform precoding state.

Some embodiments of the present disclosure provide a method performed by a BS. The method may include: transmitting, to a UE, first indication information indicating a transform precoding state for a PUSCH, wherein the transform precoding state indicates whether a transform precoding is enabled or not; and determining whether the transform precoding state is applied to a first PUSCH transmission.

Some embodiments of the present disclosure provide a method performed by a BS. The method may include: transmitting, to a UE, first indication information indicating a first transform precoding state, wherein the first transform precoding state indicates whether a transform precoding is enabled or not; and receiving, from the UE, a first PUSCH based on the first transform precoding state.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 is a flow chart illustrating an exemplary method for transform precoding state switching according to some embodiments of the present application;

FIG. 3 illustrates an exemplary method for determining whether to apply the transform precoding state according to some embodiments of the present application;

FIG. 4 is a flow chart illustrating an exemplary method for transform precoding state switching according to some embodiments of the present application;

FIG. 5 illustrates exemplary cases for determining whether to apply the transform precoding state according to some embodiments of the present application;

FIG. 6 illustrates an exemplary timer for determining whether to apply the transform precoding state according to some embodiments of the present application;

FIG. 7 is a flow chart illustrating an exemplary method for transform precoding state switching according to some embodiments of the present application;

FIG. 8 is a flow chart illustrating an exemplary method for transform precoding state switching according to some embodiments of the present application;

and

FIG. 9 illustrates a simplified block diagram of an exemplary apparatus for transform precoding state switching according to some embodiments of the present application.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

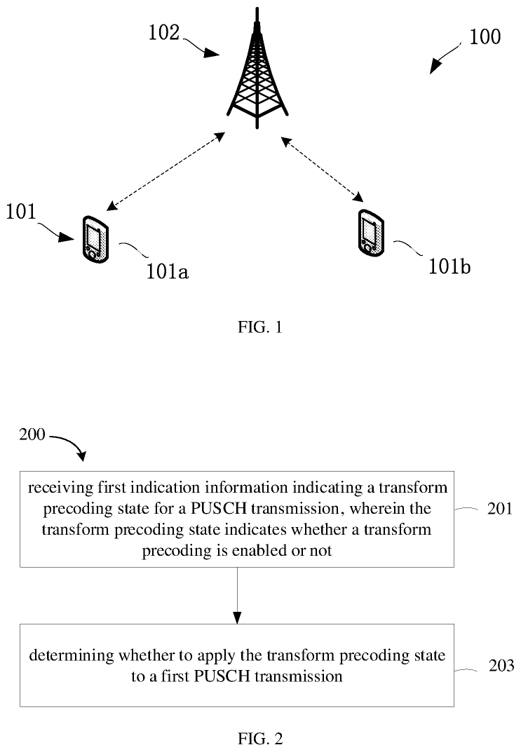

FIG. 1 illustrates a schematic diagram of a wireless communication system 100 in accordance with some embodiments of the present disclosure.

As shown in FIG. 1, wireless communication system 100 may include some UEs 101 (e.g., UE 101a and UE 101b) and a base station (e.g., BS 102). Although a specific number of UEs 101 and BS 102 is depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

A UE may transmit data signals to a base station (BS) via a PUSCH. A PUSCH transmission(s) may be dynamically scheduled by a UL grant in a DCI, or may be transmitted based on a configured grant (CG) such as CG Type 1 or CG type 2 as specified in 3GPP standard documents. The CG Type 1 based PUSCH transmission may refer to that: a PUSCH transmission is semi-statically configured to operate in response to the reception of a higher layer parameter (e.g., the parameter configuredGrantConfig including rrc-ConfiguredUplinkGrant as specified in 3GPP standard documents) without the detection of a UL grant in a DCI. The CG Type 2 based PUSCH transmission may refer to that: a PUSCH transmission is semi-persistently scheduled by a UL grant in a valid activation DCI after the reception of a higher layer parameter (e.g., the parameter configuredGrantConfig not including rrc-ConfiguredUplinkGrant as specified in 3GPP standard documents).

Various waveforms, including for example, DFT-s-OFDM waveform and CP-OFDM waveform, are supported in a PUSCH transmission(s) and may have their respective advantages in different scenarios. For example, for a PUSCH transmission with a DFT-s-OFDM waveform, only one layer is supported while for a PUSCH transmission with a CP-OFDM waveform, up to four layers can be supported. Moreover, compared with the CP-OFDM waveform, the peak to average power ratio (PAPR) of the DFT-s-OFDM waveform is relatively lower, but the efficiency of a UE's power amplifier is higher. Given this, different waveforms may be used in different scenarios. For example, if a UE is at a cell center or near the cell center, it would be advantageous to transmit a PUSCH with a CP-OFDM waveform for a higher throughput. In another example, if a UE is at a cell edge or near a cell edge, it would be advantageous to transmit a PUSCH a DFT-s-OFDM waveform since it can provide better coverage due to higher power efficiency.

In some embodiments of the present disclosure, the waveform applied to a PUSCH transmission may be indicated by whether a transform precoding is enabled. For example, if the transform precoding is enabled, a DFT-s-OFDM waveform may be applied; and if the transform precoding is disabled, a CP-OFDM may be applied.

In some embodiments of the present disclosure, a BS may semi-statically configure a waveform for a PUSCH transmission by higher layer (e.g., a layer higher than a physical layer) signaling (e.g., radio resource control (RRC) signaling). Switching between different waveforms by higher layer signaling is relatively slow.

Embodiments of the present application further propose solutions to dynamically switch between different waveforms, thereby facilitating the advantages of different waveforms in different scenarios (e.g., a multi-layer PUSCH transmission or a higher UE power efficiency for enhanced coverage). For example, embodiments of the present application propose solutions for transform precoding state switching for a PUSCH, which can at least implement the dynamic switch between different waveforms. The dynamic waveform switch may be explicitly indicated or implicitly determined. For example, embodiments of the present application propose solutions for determine when and how to apply dynamically configured waveforms. More details on the embodiments of the present application will be illustrated in the following text in combination with the appended drawings.

FIG. 2 is a flow chart illustrating an exemplary method 200 for transform precoding state switching according to some embodiments of the present application. The method in FIG. 2 may be implemented by a UE (e.g., UE 101 as shown in FIG. 1). Details described in all of the foregoing embodiments of the present disclosure are applicable for the embodiments shown in FIG. 2.

In the exemplary method shown in FIG. 2, in step 201, the UE may receive first indication information from a network (e.g., BS 102 in FIG. 1). The first indication information may indicate a transform precoding state for a PUSCH transmission (e.g., which may be any PUSCH transmission after the first indication information, for example, PUSCH transmission #0). The transform precoding state may indicate whether a transform precoding is enabled or not (i.e., the transform precoding state may be the transform precoding is enabled or the transform precoding is disabled).

In the case that the transform precoding is enabled, a certain type of waveform, for example, a DFT-s-OFDM waveform, may be applied to the PUSCH transmission. In the case that the transform precoding is disabled, another type of waveform, for example, a CP-OFDM may be applied to the PUSCH transmission. The first indication information indicating a transform precoding state for a PUSCH transmission may also be referred to as the first indication information indicating a UL waveform for a PUSCH transmission.

In some embodiments of the present application, the first indication information may include a DCI. In such embodiments, the UE may receive configuration information indicating whether a field indicating the transform precoding state exists or not in the DCI. In an embodiment of the present application, the configuration information may be received via higher layer signaling (e.g., RRC signaling).

According to an embodiment of the present application, the configuration information may directly indicate whether a field indicating the transform precoding state exists or not in the DCI. According to another embodiment of the present application, the configuration information may indirectly indicate whether a field indicating the transform precoding state exists or not in the DCI. For example, the configuration information may indicate that the UE supports transform precoding state switch or dynamic switching of UL waveforms, which implies that the DCI field exists. For example, the configuration information may indicate that the UE does not support transform precoding state switch or dynamic switching of UL waveforms, which implies that the DCI field does not exist.

According to an embodiment of the present application, the configuration information may be configured per UE. For example, for a specific UE (e.g., UE 101a in FIG. 1), the configuration information may indicate the field indicating the transform precoding state exists. For another UE (e.g., UE 101b in FIG. 1), the configuration information may indicate the field indicating the transform precoding state does not exist.

According to an embodiment of the present application, the configuration information may be configured per a DCI format. For example, two RRC parameters may be configured for DCI format 0_1 and DCI format 0_2 separately. Each of the two parameters indicates whether a field for indicating the transform precoding state exists or not in the corresponding DCI format. For example, for a normal DCI (e.g., DCI format 0_1), the configuration information may indicate a field indicating the transform precoding state does not exist. For a compacted DCI (e.g., DCI format 0_2), the configuration information may indicate a field indicating the transform precoding state exists.

In the case that the configuration information indicates that the field exists, then the first indication information may include the field indicating the transform precoding state.

In some embodiments, the field may indicate whether the transform precoding is enabled or not directly. For example, the field may include at least one bit. For example, the value “1” of the bit may indicate that the transform precoding is not enabled (i.e., disabled), which may mean that a CP-OFDM waveform is to be applied to a PUSCH transmission, the value “O” of the bit may indicate that the transform precoding is enabled, which may mean that a DFT-s-OFDM waveform is to be applied to a PUSCH transmission; or vice versa. Then, based on the DCI including the field, the UE may determine which UL waveform is to be applied to a subsequent PUSCH transmission(s).

In some other embodiments, the field may indicate whether the transform precoding state is switched from the last applied transform precoding state to another transform precoding state. For example, the field may include at least one bit. For example, the value “1” of the bit may indicate that the transform precoding state is switched from the last applied transform precoding state to another transform precoding state, the value “0” of the bit may indicate that the transform precoding state is not switched from the last applied transform precoding state to another transform precoding state; or vice versa. Then, based on the DCI including the field, the UE may determine which UL waveform is to be applied to a subsequent PUSCH transmission(s).

In some other embodiments, the field may indicate that the transform precoding state is switched from one of an enabled state and a disabled state to the other state of the enabled state and disabled state. For example, the field may include at least one bit. For example, the value “1” of the bit may indicate that the transform precoding is switched from an enabled state to a disabled state, and the value “0” of the bit may indicate that the transform precoding state is switched from a disabled state to an enabled state; or vice versa. Then, based on the DCI including the field, the UE may determine which UL waveform is to be applied to a subsequent PUSCH transmission(s).

In some other embodiments, the field may indicate that the transform precoding state is switched from a default transform precoding state to another state. For example, the field may include at least one bit. For example, the value “1” of the bit may indicate that the transform precoding is switched from the default transform precoding state to another state, and the value “0” of the bit may indicate that the transform precoding state is not switched from the default transform precoding state to another state (i.e., the transform precoding state is kept as the default transform precoding state); or vice versa. Then, based on the DCI including the field, the UE may determine which UL waveform is to be applied to a subsequent PUSCH transmission(s).

In an embodiment of the present application, the default transform precoding state may be determined based on higher layer signaling(s) (e.g., RRC layer signaling).

For example, for a PUSCH transmission scheduled by an random access response (RAR) UL grant, or for a PUSCH scheduled by fallbackRAR UL grant, or for a PUSCH scheduled by DCI format 0_0 with a CRC scrambled by temporary cell radio network temporary identifier (TC-RNTI), the default transform precoding state (e.g., the transform precoding is either ‘enabled’ or ‘disabled’) may be determined according to the higher layer configured parameter msg3-transformPrecoder as specified in 3GPP standard documents.

In another example, for a MsgA PUSCH transmission, the default transform precoding state (e.g., the transform precoding is either ‘enabled’ or ‘disabled’) may be determined according to higher layer the configured parameter msgA-TransformPrecoder as specified in 3GPP standard documents. In the case that the higher layer parameter msgA-TransformPrecoder is not configured, the default transform precoding state (e.g., the transform precoding is either ‘enabled’ or ‘disabled’) may be determined according to the higher layer configured parameter msg3-transformPrecoder as specified in 3GPP standard documents.

In yet another example, for a PUSCH transmission scheduled by a PDCCH with a CRC scrambled by CS-RNTI with new data indicator (NDI)=1, scrambled by cell RNTI (C-RNTI), scrambled by modulation coding scheme C-RNTI (MCS-C-RNTI), or scrambled by semi-persistent channel state information RNTI (SP-CSI-RNTI):
If a DCI with the scheduling grant was received with DCI format 0_0, then, for the PUSCH transmission scheduled by the DCI, the default transform precoding state (e.g., the transform precoding is either ‘enabled’ or ‘disabled’) may be determined according to the higher layer configured parameter msg3-transformPrecoder as specified in 3GPP standard documents.
1 If the DCI with the scheduling grant was not received with DCI format 0_0:
   If the UE is configured with the higher layer parameter transformPrecoder in pusch-Config, then, for the PUSCH transmission scheduled by the DCI, the default transform precoding state (e.g., the transform precoding is either ‘enabled’ or ‘disabled’) may be determined according to transformPrecoder as specified in 3GPP standard documents.
   If the UE is not configured with the higher layer parameter transformPrecoder in pusch-Config, then, for the PUSCH transmission scheduled by the DCI, the default transform precoding state (e.g., the transform precoding is either ‘enabled’ or ‘disabled’) may be determined according to the higher layer configured parameter msg3-transformPrecoder as specified in 3GPP standard documents.

In yet another ample, for a PUSCH transmission with a configured grant:
If the UE is configured with the higher layer parameter transformPrecoder in configuredGrantConfig, then, for the PUSCH transmission, the default transform precoding state (e.g., the transform precoding is either ‘enabled’ or ‘disabled’) may be determined according to the parameter transformPrecoder as specified in 3GPP standard documents.
If the UE is not configured with the higher layer parameter transformPrecoder in configuredGrantConfig, then, for the PUSCH transmission scheduled by the DCI, the default transform precoding state (e.g., the transform precoding is either ‘enabled’ or ‘disabled’) may be determined according to the higher layer configured parameter msg3-transformPrecoder as specified in 3GPP standard documents.

In another embodiment of the present application, the default transform precoding state (the transform precoding is either ‘enabled’ or ‘disabled’) may be pre-defined, for example, in 3GPP standard documents.

In the case that the configuration information indicates that the field does not exist, the DCI does not include the field indicating transform precoding state, and the transform precoding state may be a default transform precoding state as stated above.

In some cases, a fallback DCI (e.g., DCI format 0_0) may always not include the field indicating transform precoding state regardless of the configuration information. For example, even if the configuration information indicates that the field exists, the fallback DCI may not include the field. The transform precoding state for a fallback DCI may be a default transform precoding state as stated above.

In some other embodiments of the present application, the first indication information may include a DCI. In such embodiments, the UE may receive configuration information indicating a set of elements, each element is associated with one or more transform precoding states, and the DCI indicates one of the set of elements.

In an embodiment, the DCI may include a field indicating one of the set of elements. The number of bits of the field depends on the number of elements in the set of elements, for example, the number of bits may be equal to log₂^{N}, wherein N is the number of elements in the set of elements. In some cases, each element may be associated with one or two transform precoding states (e.g., corresponding to one or two UL waveforms which are from CP-OFDM and DFT-s-OFDM waveforms).

For example, the following Table 1 shows an example of four elements indicated by the configuration information.

Referring to Table 1, each row may represent an element. The first element may be associated with one transform precoding state, which is “disabled” (i.e., the transform precoding state is disabled, for example, the UL waveform is CP-OFDM waveform). The second element may be associated with two transform precoding states, the first state is “disabled” and the second state is “enabled”. The third element may be associated with one transform precoding state, which is “enabled” (i.e., the transform precoding state is enabled, for example, the UL waveform is DFT-S-OFDM waveform). The fourth element may be associated with two transform precoding states, the first state is “enabled” and the second state is “disabled.”

TABLE 1

Disabled (e.g., CP-OFDM)
Disabled (e.g., CP-OFDM), Enabled (e.g., DFT-S-OFDM)
Enabled (e.g., DFT-S-OFDM)
Enabled (e.g., DFT-S-OFDM), Disabled (e.g., CP-OFDM)

The UE may receive a DCI which includes a field indicating one element. For example, the field may include 2 bits, and the value of the field may be “01,” which may indicate the second element in the set of elements.

In the cast that the field indicates two transform precoding states (hereinafter, transform precoding state #1 and transform precoding state #2), the two transform precoding states may be applied to a number of repetitions of the PUSCH transmission. For example, in the case that the second row in Table 1 is indicated, transform precoding state #1 may refer to the disabled state, and transform precoding state #2 may refer to the enable state. The number of repetitions may be a number of PUSCH Type A repetitions as specified in 3GPP standard documents or may be a number of PUSCH Type B repetitions as specified in 3GPP standard documents.

In the case that a number of repetitions of the PUSCH transmission is two, transform precoding state #1 is indicated to be applied to the first repetition and transform precoding state #2 is indicated to be applied to the second repetition.

In the case that the number of repetitions of the PUSCH transmission is larger than two and cyclic mapping is enabled (e.g., “PUSCH-Config” may include a parameter “cyclicMapping OF WF” indicating that the mapping type of a waveform is cyclic mapping), the UE may determine that transform precoding state #1 and transform precoding state #2 are indicated to be applied to the number of repetitions alternatively. For example, transform precoding states #1 and #2 are indicated to be applied to the first repetition and the second repetition of the number of repetitions respectively, and the same mapping pattern continues for the remaining repetitions of the number of repetitions (if any). In such cases, the same mapping pattern may refer to that transform precoding state #1 is indicated to be firstly applied to a repetition and transform precoding state #2 is indicated to be applied to a following repetition. For example, transform precoding states #1 and #2 are indicated to be applied to the third repetition and the fourth repetition of the number of repetitions respectively.

In the case that a number of repetitions of the PUSCH transmission is larger than two and sequential mapping is enabled (e.g., “PUSCH-Config” may include a parameter “sequentialMapping OF WF” indicating that the mapping type of a waveform is sequential mapping), the UE may determine that transform precoding states #1 and #2 are indicated to be applied to every two repetitions of the number of repetitions alternatively. For example, transform precoding state #1 is indicated to be applied to the first repetition and the second repetition of the number of repetitions, and transform precoding state #2 is indicated to be applied to the third repetition and the fourth repetition of the number of repetitions, and the same mapping pattern continues to the remaining repetitions of the number of repetitions (if any). In such cases, the same mapping pattern may refer to that transform precoding state #1 is indicated to be firstly applied to two repetitions and transform precoding state #2 is indicated to be applied to the following two repetitions. For example, transform precoding state #1 is indicated to be applied to the fifth repetition and the sixth repetition of the number of repetitions, and transform precoding state #2 is indicated to be applied to the seventh repetition and the eighth repetition of the number of repetitions.

In some other embodiments of the present application, the first indication information may include a DCI. In such embodiments, the UE may obtain a table (e.g., a TDRA table). In an embodiment, the table may be configured by the BS via higher layer signaling (e.g., RRC signaling). In another embodiment, the table may be pre-defined (e.g., fixed in 3GPP standard documents). The table may include one or more rows (i.e., entries). Each row may indicate at least one of: a slot offset (e.g., K2 as specified in 3GPP standard documents); a SLIV or a start symbol and an allocation length; a PUSCH mapping type (e.g., PUSCH mapping type A and/or PUSCH mapping type B as specified in 3GPP standard documents); a transform precoding state for a PUSCH transmission; or a number of repetitions to be applied to a PUSCH transmission. For example, a row may include a parameter indicating the transform precoding state.

Specifically, a row may indicate whether the transform precoding is enabled or not directly, or indicate that the transform precoding state is switched from one of an enabled state and a disabled state to the other state of the enabled state and disabled state, or indicate whether the transform precoding state is switched from a last applied transform precoding state to another state, or indicate whether the transform precoding state is switched from a default transform precoding state to another state.

In such embodiments, the DCI may include a TDRA field which indicates a row of the table. For example, the TDRA field with a value “m” may indicate a row index “m+1” of the table. Consequently, after receiving the DCI, the UE may determine a row in the table, and thus determine the transform precoding state indicated by the row.

For example, the following Table 2 shows an example of a TDRA table.

TABLE 2

| | | | | Transform |
|---|---|---|---|---|
| Row | | PUSCH | | precoding |
| index | Slot offset | mapping type | SLIV | state |
| #1 | Slot offset #0 | PUSCH mapping | SLIV #0 | Enabled |
| | | type #0 | | |
| #2 | Slot offset #1 | PUSCH mapping | SLIV #1 | Disabled |
| | | type #1 | | |
| . . . | . . . | . . . | . . . | . . . |
| #N | Slot offset #N-1 | PUSCH mapping | SLIV #N-1 | Enabled |
| | | type #N-1 | | |

Referring to Table 2, the table includes N row (e.g., row #1, row #2, . . . , row #N). Each row may indicate: a slot offset, a SLIV, a PUSCH mapping type, and a transform precoding state. In the example of Table 2, each row may directly indicate whether the transform precoding is enabled or disabled. For example, row #1 may indicate: a slot offset #0, a SLIV #0, a PUSCH mapping type #0, and the transform precoding is enabled. In this example, the value of TDRA field in the DCI being equal to 0 may indicates row #1 in the table. After receiving the DCI, the UE may determine that the transform precoding is enabled for a PUSCH transmission, which indicates that the DFT-S-OFDM waveform may be applied to a subsequent PUSCH transmission(s).

The following Table 3 shows another example of the TDRA table.

TABLE 3

| | | | | Transform |
|---|---|---|---|---|
| Row | | PUSCH | | precoding |
| index | Slot offset | mapping type | SLIV | state |
| #1 | Slot offset #0 | PUSCH mapping | SLIV #0 | Switching |
| | | type #0 | | |
| #2 | Slot offset #1 | PUSCH mapping | SLIV #1 | No switching |
| | | type #1 | | |
| . . . | . . . | . . . | . . . | . . . |
| #N | Slot offset #N-1 | PUSCH mapping | SLIV #N-1 | Switching |
| | | type #N-1 | | |

Referring to Table 3, the difference between table 3 and Table 2 is that in Table 3, each row may indicate whether the transform precoding state is switched from the last applied transform precoding state (or a default transform precoding state) to another state, thereby indicating the transform precoding state for a PUSCH transmission. For example, taking row #2 in Table 3 as an example, it may indicate that the transform precoding state is not switched from the last applied transform precoding state to another state. In the case that the last applied transform precoding state is a disabled state (i.e., the transform precoding is disabled, which may indicate that the last applied UL waveform is CP-OFDM waveform), the UE may determine that the CP-OFDM waveform may be applied to a subsequent PUSCH transmission(s).

In some cases, one or more rows of the table may not indicate the transform precoding state, which may suggest that the corresponding transform precoding state is a default transform precoding state as stated above.

In some cases, a row of the table may indicate a number of repetitions of the PUSCH transmission. In such cases, a TDRA field of the DCI may indicate a corresponding row of the table. For example, the TDRA field with a value “m” may indicate a row index “m+1” of the table. Consequently, after receiving the DCI, the UE may determine a row in the table, and thus determine the number of repetitions for the PUSCH transmission indicated by the row.

Whether the transform precoding state is enabled or disabled may be based on the indicated the number of repetitions and a threshold. For example, in the case that the number of repetitions is larger than the threshold, transform precoding state #A1 is indicated to be applied to the PUSCH transmission; in the case that the number of repetitions is smaller than or equal to the threshold, transform precoding state #A2 is indicated to be applied to the PUSCH transmission. The threshold may be configured by a network (e.g., via higher layer signaling) or may be pre-defined (e.g., fixed in 3GPP standard documents). In an embodiment of the present application, transform precoding state #A1 may be that the enabled state (i.e., the transform precoding is enabled, which may indicate that a DFT-S-OFDM waveform is to be applied); and transform precoding state #A2 may be the disabled state (i.e., the transform precoding is disabled, which may indicate that a CP-OFDM waveform is to be applied).

In some other embodiments of the present application, the first indication information may include a DCI including a FDRA field. A first value of the FDRA field may indicate a first resource allocation type and a second value of the FDRA field may indicate a second resource allocation type. In such embodiments, in the case that the first resource allocation type is indicated, the transform precoding is disabled; in the case that the second resource allocation type is indicated, the transform precoding is enabled. For example, the first value may be “0” and the second value may be “1”, and the first resource allocation type may be resource allocation type 0 as specified in 3GPP standard documents and the second resource allocation type may be resource allocation type 1 as specified in 3GPP standard documents.

For example, a plurality of uplink resource allocation schemes (e.g., type 0, type 1 and type 2) may be supported. In the case that the parameter resourceAllocation as specified in 3GPP standard documents is configured as ‘dynamicSwitch’, a certain bit (e.g., the most significant bit (MSB)) of the FDRA field may be used to indicate resource allocation type 0 or resource allocation type 1. For example, the value of the MSB being “0” may indicate resource allocation type 0 and the value of the MSB being “1” may indicate resource allocation type 1. In the case that the resource allocation type 0 is indicated, the CP-OFDM waveform (e.g., the transform precoding is disabled) may be used for a PUSCH transmission; in the case that the resource allocation type 1 is indicated, a DFT-s-OFDM waveform (e.g., the transform precoding is enabled) may be used for a PUSCH transmission.

In some other embodiments of the present application, the first indication information may include a DCI. In such embodiments, the UE may receive configuration information indicating an association between a SRS resource set and a transform precoding state (e.g., disabled or enabled state). For example, the configuration information may indicate that a first SRS resource set is associated with transform precoding state #B1 and a second SRS resource set is associated with transform precoding state #B2. Transform precoding states #B1 and #B2 may be the disabled state and enabled state, respectively; or vice versa. The DCI may include a SRS resource indicator which indicates at least one SRS resource set for the PUSCH transmission. The transform precoding state to be applied can be determined based on the SRS resource indicator and the configuration information.

In some examples, the number of repetitions of the PUSCH transmission may be larger than one. A first value (e.g., “00”) of the SRS resource indicator may indicate the first SRS resource set, and the associated transform precoding state (e.g., transform precoding state #B1) may be indicated to be applied to all of the number of repetitions.

In some examples, the number of repetitions of the PUSCH transmission may be larger than one. A second value (e.g., “01”) of the SRS resource indicator may indicate the second SRS resource set and the associated transform precoding state (e.g., transform precoding state #B2) may be indicated to be applied to all of the number of repetitions.

In some examples, a third value (e.g., “10”) of the SRS resource indicator may indicate the first SRS resource set and the second SRS resource set, and the associated transform precoding states (e.g., transform precoding state #B1 and transform precoding state #B2) may be indicated to be applied to the number of repetitions according to the following methods:
In the case that the number of repetitions of the PUSCH transmission is two, transform precoding state #B1 is indicated to be applied to the first repetition of the number of repetitions and transform precoding state #B2 is indicated to be applied to the second repetition of the number of repetitions.
In the case that the number of repetitions of the PUSCH transmission is larger than two and cyclic mapping is enabled (e.g., “PUSCH-Config” may include a parameter “cyclicMapping” indicating that the mapping type of a waveform is cyclic mapping), the UE may determine that transform precoding state #B1 and transform precoding state #B2 are indicated to be applied to the number of repetitions alternatively. For example, transform precoding states #B1 and #B2 are indicated to be applied to the first repetition and the second repetition of the number of repetitions respectively, and the same mapping pattern continues for the remaining repetitions of the number of repetitions (if any). In such cases, the same mapping pattern may refer to that transform precoding state #B1 is indicated to be firstly applied to a repetition and transform precoding state #B2 is indicated to be applied to a following repetition. For example, transform precoding states #B1 and #B2 are indicated to be applied to the third repetition and the fourth repetition of the number of repetitions, respectively.
In the case that the number of repetitions of the PUSCH transmission is larger than two and a sequential mapping is enabled (e.g., “PUSCH-Config” may include a parameter “sequentialMapping” indicating that the mapping type of a waveform is sequential mapping), the UE may determine that transform precoding states #B1 and #B2 are indicated to be applied to every two repetitions of the number of repetitions alternatively. For example, transform precoding state #B1 is indicated to be applied to the first repetition and the second repetition of the number of repetitions, and transform precoding state #B2 is indicated to be applied to the third repetition and the fourth repetition of the number of repetitions, and the same mapping pattern continues to the remaining repetitions of the number of repetitions (if any). In such cases, the same mapping pattern may refer to that transform precoding state #B1 is indicated to be firstly applied to two repetitions and transform precoding state #B2 is indicated to be applied to the following two repetitions. For example, transform precoding state #B1 is indicated to be applied to the fifth repetition and the sixth repetition of the number of repetitions, and transform precoding state #B2 is indicated to be applied to the seventh repetition and the eighth repetition of the number of repetitions.

In some examples, a fourth value (e.g., “11”) of the SRS resource indicator may indicate the second SRS resource set and the first SRS resource set, and the associated transform precoding states (e.g., transform precoding state #B2 and transform precoding state #B1) may be indicated to be applied to the number of repetitions according to the following methods:
In the case that a number of repetitions of the PUSCH transmission is two, transform precoding state #B2 is indicated to be applied to the first repetition of the number of repetitions and transform precoding state #B1 is indicated to be applied to the second repetition of the number of repetitions.
In the case that the number of repetitions of the PUSCH transmission is larger than two and cyclic mapping is enabled (e.g., “PUSCH-Config” may include a parameter “cyclicMapping” indicating that the mapping type of a waveform is cyclic mapping), the UE may determine that transform precoding state #B2 and transform precoding state #B1 are indicated to be applied to the number of repetitions alternatively. For example, transform precoding states #B2 and #B1 are indicated to be applied to the first repetition and the second repetition of the number of repetitions respectively, and the same mapping pattern continues for the remaining repetitions of the number of repetitions (if any). In such cases, the same mapping pattern may refer to that transform precoding state #B2 is indicated to be firstly applied to a repetition and transform precoding state #B1 is indicated to be applied to a following repetition. For example, transform precoding states #B2 and #B1 are indicated to be applied to the third repetition and the fourth repetition of the number of repetitions respectively.
In the case that a number of repetitions of the PUSCH transmission is larger than two and a sequential mapping is enabled (e.g., “PUSCH-Config” may include a parameter “sequentialMapping” indicating that the mapping type of a waveform is sequential mapping), the UE may determine that transform precoding states #B2 and #B1 are indicated to be applied to every two repetitions of the number of repetitions alternatively. For example, transform precoding state #B2 is indicated to be applied to the first repetition and the second repetition of the number of repetitions, and transform precoding state #B1 is indicated to be applied to the third repetition and the fourth repetition of the number of repetitions, and the same mapping pattern continues to the remaining repetitions of the number of repetitions (if any). In such cases, the same mapping pattern may refer to that transform precoding state #B2 is indicated to be firstly applied to two repetitions and transform precoding state #B1 is indicated to be applied to the following two repetitions. For example, transform precoding state #B2 is indicated to be applied to the fifth repetition and the sixth repetition of the number of repetitions, and transform precoding state #B1 is indicated to be applied to the seventh repetition and the eighth repetition of the number of repetitions.

The number of repetitions may be a number of PUSCH Type A repetitions as specified in 3GPP standard documents or may be a number of PUSCH Type B repetitions as specified in 3GPP standard documents.

For example, two SRS resource sets (e.g., the first SRS resource set and the second SRS resource set) may be configured in srs-ResourceSetToAddModList or srs-ResourceSetToAddModListDCI-0-2 with a higher layer parameter “usage” in SRS-ResourceSet set to ‘codebook’ or ‘noncodebook’.

For PUSCH Type A repetitions, it is assumed that the number of repetitions is K (corresponding to K consecutive slots). In the case that K>1, the same symbol allocation may be applied across the K consecutive slots and the PUSCH may be limited to a single transmission layer. The UE may repeat a transport block (TB) across the K consecutive slots applying the same symbol allocation in each slot.

In some embodiments, it is assumed that the UE may receive configuration information indicating that the first SRS resource set is associated with a disabled state and the second SRS resource set is associated with that an enabled state. For example, the above association may be implemented by adding a parameter indicating a “disabled” or “enabled” state in a resource set configuration.

After receiving a DCI, the UE may determine a SRS resource indicator included in the DCI, the SRS resource indicator may indicate at least one SRS resource set. Then, at least one transform precoding state corresponding to the at least one SRS resource set can be determined based on the configuration information.

The association of the first and second SRS resource set in srs-ResourceSetToAddModList or srs-ResourceSetToAddModListDCI-0-2 to each slot (e.g., each repetition) can be determined as follows:
In the case that the DCI format (e.g., format 0_1 or DCI format 0_2) indicates a first codepoint (e.g., “00”) for the SRS resource set indicator, the first SRS resource set is associated with all K consecutive slots, and the associated “disabled” state may be applied to all of the K repetitions (e.g., all of the K repetitions may use CP-OFDM waveform).
In the case that the DCI format (e.g., format 0_1 or DCI format 0_2) indicates a second codepoint (e.g., “01”) for the SRS resource set indicator, the second SRS resource set is associated with all K consecutive slots, and the associated “enabled” state may be applied to all of the K repetitions (e.g., all of the K repetitions may use DFT-s-OFDM waveform).
In the case that the DCI format (e.g., format 0_1 or DCI format 0_2) indicates a third codepoint (e.g., “10”) for the SRS resource set indicator, the association between the first and second SRS resource set and K consecutive slots can be determined as follows:
   When K=2, the first and second SRS resource sets are applied to the first and second slots of two consecutive slots, respectively, and the “disabled” state and “enabled” state may be applied to the first and second slots of the two consecutive slots, respectively (e.g., the CP-OFDM and DFT-s-OFDM are applied to the first and second slots of 2 consecutive slots, respectively).
   When K>2 and cyclicMapping in PUSCH-Config is enabled, the first and second SRS resource sets are applied to the first and second slot of K consecutive slots, respectively, and the same SRS resource set mapping pattern continues to the remaining slots of K consecutive slots, and the “disabled” state and “enabled” state may be applied to the first and second slot of K consecutive slots, respectively, and the same mapping pattern continues to the remaining slots of K consecutive slots (e.g., the CP-OFDM and DFT-s-OFDM are applied to the first and second slot of K consecutive slots, respectively, and the same waveform mapping pattern continues to the remaining slots of K consecutive slots).
   When K>2 and sequentialMapping in PUSCH-Config is enabled, the first SRS resource set is applied to the first and second slots of K consecutive slots, and the second SRS resource set is applied to the third and fourth slots of K consecutive slots, and the same SRS resource set mapping pattern continues to the remaining slots of K consecutive slots; and the “disabled” state is applied to the first and second slots of K consecutive slots, and “enabled” state is applied to the third and fourth slots of K consecutive slots, and the same waveform mapping pattern continues to the remaining slots of K consecutive slots (e.g., the CP-OFDM is applied to the first and second slots of K consecutive slots, and the DFT-s-OFDM is applied to the third and fourth slots of K consecutive slots, and the same waveform mapping pattern continues to the remaining slots of K consecutive slots).
In the case that the DCI format (e.g., format 0_1 or DCI format 0_2) indicates a fourth codepoint (e.g., “11”) for the SRS resource set indicator, the association between first and second SRS resource set and K consecutive slots can be determined as follows:
   When K=2, the second and first SRS resource sets are applied to the first and second slots of two consecutive slots, respectively, and the “enabled” state and “disabled” state may be applied to the first and second slots of the two consecutive slots, respectively (e.g., the DFT-s-OFDM and CP-OFDM are applied to the first and second slots of 2 consecutive slots, respectively).
   When K>2 and cyclicMapping in PUSCH-Config is enabled, the second and first SRS resource sets are applied to the first and second slot of K consecutive slots, respectively, and the same SRS resource set mapping pattern continues to the remaining slots of K consecutive slots, and the “enabled” state and “disabled” state may be applied to the first and second slot of K consecutive slots, respectively, and the same mapping pattern continues to the remaining slots of K consecutive slots (e.g., the DFT-s-OFDM and CP-OFDM are applied to the first and second slot of K consecutive slots, respectively, and the same waveform mapping pattern continues to the remaining slots of K consecutive slots).
   When K>2 and sequentialMapping in PUSCH-Config is enabled, the second SRS resource set is applied to the first and second slots of K consecutive slots, and the first SRS resource set is applied to the third and fourth slots of K consecutive slots, and the same SRS resource set mapping pattern continues to the remaining slots of K consecutive slots; and the “enabled” state is applied to the first and second slots of K consecutive slots, and “disabled” state is applied to the third and fourth slots of K consecutive slots, and the same waveform mapping pattern continues to the remaining slots of K consecutive slots (e.g., the DFT-s-OFDM is applied to the first and second slots of K consecutive slots, and the CP-OFDM is applied to the third and fourth slots of K consecutive slots, and the same waveform mapping pattern continues to the remaining slots of K consecutive slots).

Although the above descriptions are related to the first SRS resource set being associated with a disabled state and the second SRS resource set being associated with that an enabled state, it should be appreciated that the first SRS resource set may be associated with an enabled state and the second SRS resource set may be associated with a disabled state, and corresponding modifications to the above descriptions may be apparent to those skilled in the art.

For a number of PUSCH Type B repetitions, when two SRS resource sets are configured in srs-ResourceSetToAddModList or srs-ResourceSetToAddModListDCI-0-2 with higher layer parameter “usage” in SRS-ResourceSet set to ‘codebook’ or ‘noncodebook’, the association between the transform precoding state(s) (and SRS resource set(s)) and nominal (actual) PUSCH repetitions (i.e., PUSCH Type B repetitions) follows the same method as the association between the transform precoding state(s) (and SRS resource set(s)) and PUSCH Type A repetitions. The only difference is that in the case of PUSCH Type B repetition, nominal (actual) PUSCH repetitions is considered instead of slots as in PUSCH Type A repetition.

In some other embodiments of the present application, the first indication information may include a DCI. The transform precoding state may be indicated by the DCI format of the DCI.

For example, in the case that the DCI format of the DCI is a fallback DCI format (e.g., DCI format 0_0), the transform precoding state may be a default transform precoding state as stated above.

In another example, the UE may receive configuration information indicating an association between a DCI format and a transform precoding state. For example, the BS may configure that DCI format 0_1 is associated with transform precoding state #C1 (e.g., a disabled state, which may correspond to CP-OFDM waveform) and DCI format 0_2 is associated with transform precoding state #C2 (e.g., an enabled state, which may correspond to DFT-s-OFDM waveform). Then, after receiving the DCI, the UE may determine the transform precoding state based on the configuration information.

In yet another example, the association between a DCI format and a transform precoding state may be pre-defined (e.g., fixed in 3GPP standard documents).

In some other embodiments of the present application, the first indication information may include a DCI. The transform precoding state may be indicated by a search space set, a CORESET, or a BWP in which the DCI is received.

In an embodiment, the UE may receive configuration information indicating an association between the search space set (SSS), the CORESET, or the BWP in which the DCI is received and a transform precoding state from the BS.

For example, the configuration information may indicate (i.e., the BS may configure) a transform precoding state per search space set, the CORESET, or the BWP.

In another example, the configuration information may indicate (i.e., the BS may configure) that a set of search space sets, or a set of CORESETs, or a set of BWPs is associated with transform precoding state #D1 and another set of search space set, or another set of CORESETs, or another set of BWPs is associated with transform precoding state #D2. Transform precoding states #D1 and #D2 may be the disabled state and enabled state, respectively; or vice versa.

Then, after receiving the DCI, the UE may determine the transform precoding state based on the configuration information.

For example, it is assumed that BS configures that SSS #1 is associated with a disabled state (may correspond to CP-OFDM waveform) and SSS #2 is associated with an enabled state (may correspond to DFT-s-OFDM waveform). Then, after receiving the DCI in any one of SSS #1 or SSS #2, the UE may determine the transform precoding state.

In another example, the association between the SSS, the CORESET, or the BWP in which the DCI is received and a transform precoding state may be pre-defined (e.g., fixed in 3GPP standard documents).

In some other embodiments of the present application, the first indication information may include a DCI, and a CRC of the DCI is scrambled by a RNTI. In such embodiments, the transform precoding state may be indicated by the RNTI. In an embodiment of the present application, the RNTI for scrambling CRC of the DCI is an RNTI specific for transform precoding state switch.

For example, it is assumed that RNTI #1 is associated with a disabled transform precoding state (e.g., CP-OFDM waveform) and RNTI #2 is associated with an enabled transform precoding state (e.g., DFT-s-OFDM waveform). In response to receiving a DCI with a CRC scrambled by RNTI #1, the UE may determine that the disabled transform precoding state transform is to be applied.

For example, the RNTI specific for transform precoding state switch may indicate a switch of the transform precoding state, for example, from the last applied (or the default) transform precoding state to another transform precoding state.

In some other embodiments of the present application, the first indication information may include a medium access control (MAC) control element (CE). In some embodiments, the MAC CE may indicate whether the transform precoding is enabled or not directly, or indicate that the transform precoding state is switched from one of an enabled state and a disabled state to the other state of the enabled state and disabled state, or indicate that the transform precoding state is switched from a last applied state to another state, or indicate that the transform precoding state is switched from a default transform precoding state to another state.

The above embodiments in step 201 may be used to determine a transform precoding state for a PUSCH transmission. Various other methods can also be applied to determine the transform precoding state.

In step 203, the UE may determine whether to apply the transform precoding state to a first PUSCH transmission. That is, in step 203, the UE may determine when to realize the transform precoding state, in other words, when the transform precoding state takes effect.

According to some embodiments of the present application, the UE may determine whether to apply the transform precoding state based on a number of time units between a time unit (time unit #1) associated with the first indication information and another time unit (time unit #2) associated with the first PUSCH transmission. The time unit may be one of: a frame, a subframe, a slot, a sub-slot, a mini-slot, a symbol, etc. Time unit #1 may be a time unit in which the first indication information is received, or a start time unit for receiving the first indication information, or an end time unit for receiving the first indication information, or a time unit in which feedback signaling (e.g., acknowledgement (ACK) or negative ACK (NACK)) for the first indication information is transmitted by the UE. Time unit #2 may be a time unit in which the first PUSCH transmission is transmitted, or a start time unit for transmitting the first PUSCH transmission, or an end time unit for transmitting the first PUSCH transmission.

The number of time units may be compared with a timing parameter (e.g., N time units) to determine whether to apply the transform precoding state to the first PUSCH transmission.

In some embodiments, the UE may report the timing parameter to the BS. In some other embodiments, the timing parameter may be pre-defined (e.g., fixed in 3GPP standard documents). In an example, the timing parameter may be a number of time units (e.g., N time units) which are needed from the time unit of signaling (i.e., the first indication information) received to the time unit of the switching takes effect.

For example, in the case that the number of time units is smaller than a timing parameter (e.g., N time units) for transform precoding state switching, the UE may determine not to apply the transform precoding state to the first PUSCH transmission. In such example, the UE may use the default transform precoding state as stated above or the last applied transform precoding state for the first PUSCH transmission. In the case that the number of time units is larger than or equal to the timing parameter, the UE may determine to apply the transform precoding state to the first PUSCH transmission.

According to some embodiments of the present application, the UE may determine to apply the transform precoding state in response to receiving the first indication information. For example, the transform precoding state takes effect immediately after the first indication information is received, which may be equivalent to “N=0” in the above embodiments.

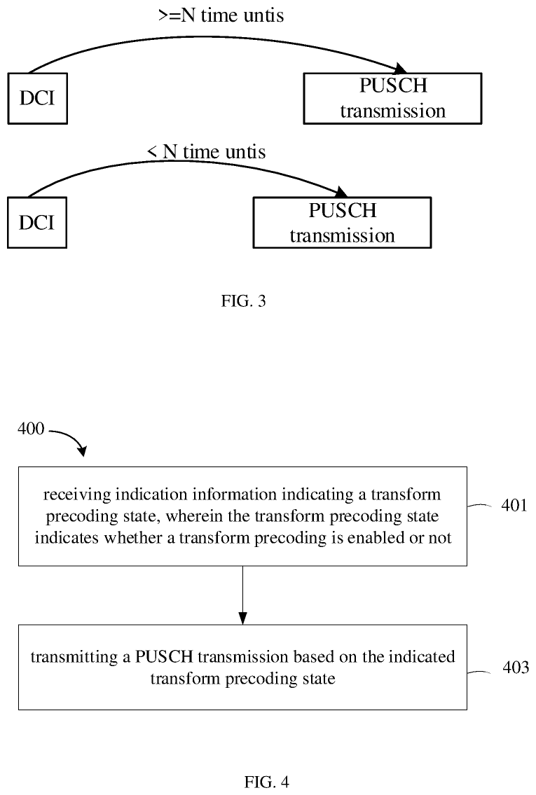

FIG. 3 illustrates an exemplary method for determining whether to apply the transform precoding state according to some embodiments of the present application. Details described in all of the foregoing embodiments of the present disclosure are applicable for the embodiments shown in FIG. 3.

Referring to FIG. 3, a UE may receive a DCI, which may indicate a switch of the transform precoding state from an “enabled” state (e.g., DFT-s-OFDM waveform) to a “disabled” state (e.g., CP-OFDM waveform). It is assumed that the timing parameter is N time units.

In the case that the number of time units between the DCI and a PUSCH transmission is larger than N or equal to N, the UE may applied the “disabled” transform precoding state (e.g., CP-OFDM waveform) to the PUSCH transmission. In the case that the number of time units between the DCI and the PUSCH transmission is smaller than N, the UE may applied the “enabled” transform precoding state (e.g., DFT-s-OFDM waveform) to the PUSCH transmission.

The first PUSCH transmission (e.g., the first PUSCH transmission as described above) in the context of the present disclosure may be one of: a CG type 1 based PUSCH transmission; a CG type 2 based PUSCH transmission; a PUSCH transmission scheduled by a fallback DCI; or a PUSCH transmission scheduled by a DCI which is not configured with transform precoding state switch. For example, the DCI which is not configured with transform precoding state switch may include: the configuration information indicates that a field indicating the transform precoding state does not exist in the DCI or a DCI format which does not support the transform precoding state switch, etc.

FIG. 4 is a flow chart illustrating an exemplary method 400 for transform precoding state switching according to some embodiments of the present application. The method in FIG. 4 may be implemented by a UE (e.g., UE 101 as shown in FIG. 1). Details described in all of the foregoing embodiments of the present disclosure are applicable for the embodiments shown in FIG. 4.

In the exemplary method shown in FIG. 4, in step 401, the UE may receive first indication information indicating a transform precoding state from a network (e.g., BS 102 shown in FIG. 1). All the embodiments in step 201 may also be applied to step 401. After receiving the first indication information, in step 403, the UE may transmit a PUSCH transmission (PUSCH transmission #E1) based on the indicated transform precoding state (transform precoding state #E1).

In some embodiments of the present application, the first indication information may include a DCI and PUSCH transmission #E1 may be a PUSCH transmission scheduled by the DCI. In some embodiments of the present application, the number of time units between the time unit associated with the first indication information and the time unit associated with PUSCH transmission #E1 is larger than or equal to a timing parameter. The descriptions regarding the time unit(s) and timing parameter with respect to FIG. 2 may also apply here. In some embodiments of the present application, PUSCH transmission #E1 may not be the PUSCH transmission scheduled by the DCI.

After transform precoding state #E1 takes effect on the PUSCH transmission #E1 (which may be determined based on the methods described with respect to FIG. 2 or other methods), the following embodiments may determine how the transform precoding state #E1 is held on.

In some embodiments of the present application, the transform precoding state #E1 takes effect only once. That is, the UE may not apply the transform precoding state #E1 to a PUSCH transmission after PUSCH transmission #E1. In some embodiments, the PUSCH transmission after PUSCH transmission #E1 may use a default transform precoding state as stated above.

In some other embodiments of the present application, the transform precoding state #E1 may take effect until another indication information (referred to as “second indication information” for clarity) indicating a transform precoding state different from transform precoding state #E1 is received. In some embodiments, all PUSCH transmissions between the first indication information and second indication information may use transform precoding state #E1. For example, said “all PUSCH transmissions” may include at least one of: a CG type 1 based PUSCH transmission; a CG type 2 based PUSCH transmission; a PUSCH transmission scheduled by a fallback DCI; or a PUSCH transmission scheduled by a DCI which is not configured with transform precoding state switch.

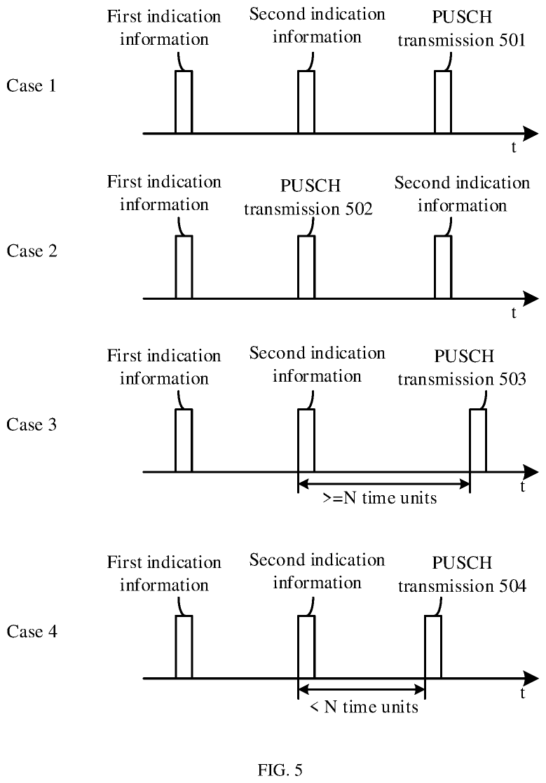

FIG. 5 illustrates exemplary cases for determining whether to apply the transform precoding state according to some embodiments of the present application. Details described in all of the foregoing embodiments of the present disclosure are applicable for the embodiments shown in FIG. 5.

Referring to case 1 in FIG. 5, the UE may receive second indication information indicating a different transform precoding state after the first indication information but before second PUSCH transmission 501. The UE may not apply transform precoding state #E1 to PUSCH transmission 501.

Referring to case 2 in FIG. 5, the UE may receive second indication information indicating a different transform precoding state after the first indication information. The UE may transmit PUSCH transmission 502 before the second indication information. The UE may apply transform precoding state #E1 to second PUSCH transmission 502.

Referring to case 3 in FIG. 5, the UE may receive second indication information indicating a different transform precoding state after the first indication information. The number of time units between the time unit associated with the second indication information and the time unit associated with PUSCH transmission 503 is larger than or equal to a timing parameter (e.g., N time units), the UE may not apply transform precoding state #E1 to PUSCH transmission 503. The UE may apply the transform precoding state indicated by the second indication information to PUSCH transmission 503.

Referring to case 4 in FIG. 5, the UE may receive second indication information indicating a different transform precoding state after the first indication information. The number of time units between the time unit associated with the second indication information and the time unit associated with PUSCH transmission 504 is smaller than the timing parameter (e.g., N time units). The UE may apply transform precoding state #E1 to PUSCH transmission 504.

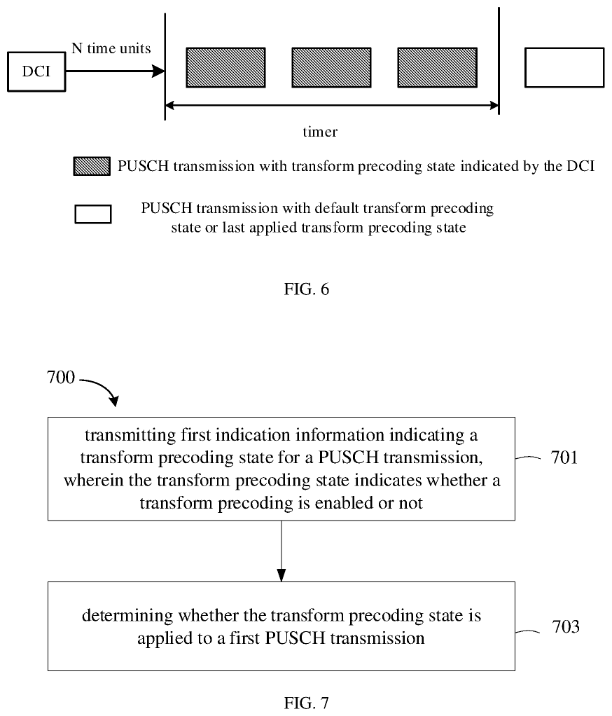

In some other embodiments, the first transform precoding state may take effect during a certain time. For example, the UE may start a timer in response to the first indication information. For example, referring to FIG. 6, the timer may be started after N time units (e.g., the timing parameter as stated above with respect to FIG. 2) of the first indication information.

The value of the timer may be configured by a network or may be pre-defined (e.g., fixed in 3GPP standard documents). In some embodiments, the value of the timer includes a number of time units. In an embodiment, the time unit is one of: a frame, a subframe, a slot, a sub-slot, a mini-slot, a symbol, etc.

All PUSCH transmissions during the timer (i.e., when the timer is running) may use transform precoding state #E1. For example, said “all PUSCH transmissions” may include at least one of: a CG type 1 based PUSCH transmission; a CG type 2 based PUSCH transmission; a PUSCH transmission scheduled by a fallback DCI; or a PUSCH transmission scheduled by a DCI which is not configured with transform precoding state switch. For PUSCH transmissions after the timer expires, the UE may not apply transform precoding state #E1 to these PUSCH transmissions, and may apply a default transform precoding state or a transform precoding state applied before transform precoding state #E1 to these PUSCH transmissions.

For example, the UE may determine whether transform precoding state #E1 is applied to a PUSCH transmission (PUSCH transmission #E2) after PUSCH transmission #E1 or not. Specifically, the UE may determine that transform precoding state #E1 is applied to PUSCH transmission #E2 when the timer is running; and determine that transform precoding state #E1 is not applied to PUSCH transmission #E2 when the timer expires. In some embodiments, the UE may apply a default transform precoding state or a transform precoding state applied before transform precoding state #E1 to PUSCH transmission #E2 after the timer expires.

In some embodiments, the UE does not expect to receive indication information to indicate the transform precoding state switching during the timer.

In some embodiments, the UE may receive indication information to indicate a transform precoding state (transform precoding state #E3) during the timer. In an embodiment, the UE does not expect that transform precoding state #E3 is not aligned with transform precoding state #E1. In other words, transform precoding state #E3 is the same as transform precoding state #E1. In another embodiment, transform precoding state #E3 may be different from transform precoding state #E1. The UE does not expect the effective times of transform precoding state #E1 and transform precoding state #E3 overlap with each other.

In some embodiments, the UE may receive indication information to indicate a transform precoding state (transform precoding state #E4) which is different from transform precoding state #E1 during the timer. In an embodiment, the UE may ignore transform precoding state #E4. In another embodiment, the UE may ignore transform precoding state #E4 when the timer is running and may apply transform precoding state #E4 for a PUSCH transmission in response to the expiry of the timer. In other words, after the timer expires, transform precoding state #E4 may take effect. In some embodiments of the present application, the timer may be used under some conditions. For example, the UE may start the timer (i.e., the timer is used) when the first indication information indicates that the transform precoding is switched from an enabled state (e.g., DFT-s-OFDM waveform) to a disabled state (e.g., CP-OFDM waveform).

In another example, the UE may start the timer (i.e., the timer is used) when the first indication information indicates that the transform precoding is switched from a disabled state (e.g., CP-OFDM waveform) to an enabled state (e.g., DFT-s-OFDM waveform).

In yet another embodiment, the UE may receive configuration information indicating the condition to start the timer. The condition may include when the first indication information indicates that the transform precoding is switched from one of the enabled state and disabled state to the other of the enabled state and disabled state. For example, the configuration information may indicate that the timer is started when the first indication information indicates that the transform precoding is switched from a disabled state to an enabled state.

According to some embodiments of the present application, whether a UE supports transform precoding state switching depends on the UE's capability. The UE may report to the BS whether the UE supports transform precoding state switching or not. According to some embodiments of the present application, a UE may receive configuration information indicating whether the UE is allowed to perform transform precoding state switching. In some embodiments, the configuration information may be based on the UE capability reported to the BS. In some embodiments, in the case that the configuration information indicates that a UE is allowed to perform transform precoding state switching, the UE may use the embodiments described with respect to FIGS. 2-6 to determine the transform precoding state for a PUSCH transmission.

FIG. 7 is a flow chart illustrating an exemplary method 700 for transform precoding state switching according to some embodiments of the present application. The method in FIG. 7 may be implemented by a BS (e.g., BS 102 as shown in FIG. 1). Details described in all of the foregoing embodiments of the present disclosure are applicable for the embodiments shown in FIG. 7.

In the exemplary method shown in FIG. 7, in step 701, the BS may transmit first indication information to a UE (e.g., UE 101a or UE 102b as shown in FIG. 1). The first indication information may indicate a transform precoding state for a PUSCH transmission (e.g., which may be any PUSCH transmission after the first indication information, for example, PUSCH transmission #0). The transform precoding state may indicate whether a transform precoding is enabled or not.

In the case that the transform precoding is enabled, a certain type of waveform, for example, a DFT-s-OFDM waveform may be applied to the PUSCH transmission. In the case that the transform precoding is disabled, another type of waveform, for example, a CP-OFDM may be applied to the PUSCH transmission. The first indication information indicating a transform precoding state for a PUSCH transmission may also be referred to as the first indication information indicating a UL waveform for a PUSCH transmission.

In some embodiments of the present application, the first indication information may include a DCI. In such embodiments, the BS may transmit configuration information indicating whether a field indicating the transform precoding state exists or not in the DCI. In an embodiment of the present application, the configuration information may be transmitted via higher layer signaling (e.g., RRC signaling).

According to an embodiment of the present application, the configuration information may be configured per UE. For example, for a specific UE (e.g., UE 101a in FIG. 1), the configuration information may indicate the field indicating the transform precoding state exists. For another UE (e.g., UE 101b in FIG. 1), the configuration information may indicate the field indicating the transform precoding state does not exist.

According to an embodiment of the present application, the configuration information may be configured per a DCI format. For example, for a normal DCI (e.g., DCI format 0_1), the configuration information may indicate a field indicating the transform precoding state does not exist, and for a compacted DCI (e.g., DCI format 0_2), the configuration information may indicate a field indicating the transform precoding state exists.

In the case that the configuration information indicates that the field exists, then the first indication information may include the field indicating the transform precoding state.

In some embodiments, the field may indicate whether the transform precoding is enabled or not directly. In such embodiments, the definitions regarding the field in FIG. 2 may also be applied herein.

In some other embodiments, the field may indicate whether the transform precoding state is switched from the last applied transform precoding state to another transform precoding state. In such embodiments, the definitions regarding the field in FIG. 2 may also be applied herein.

In some other embodiments, the field may indicate that the transform precoding state is switched from one of an enabled state and a disabled state to the other state of the enabled state and disabled state. In such embodiments, the definitions regarding the field in FIG. 2 may also be applied herein.

In some other embodiments, the field may indicate that the transform precoding state is switched from a default transform precoding state to another state. In such embodiments, the definitions regarding the field in FIG. 2 may also be applied herein.

In an embodiment of the present application, the default transform precoding state may be determined based on higher layer signaling(s) (e.g., RRC layer signaling). In such embodiment, the embodiments for determining the default transform precoding state in FIG. 2 may also be used for determining the default transform precoding state herein.

In another embodiment of the present application, the default transform precoding state (the transform precoding is either ‘enabled’ or ‘disabled’) may be pre-defined, for example, in 3GPP standard documents.

In the case that the configuration information indicates that the field does not exist, the DCI does not include the field indicating transform precoding state, and the transform precoding state may be a default transform precoding state as stated above.

In some cases, a fallback DCI (e.g., DCI format 0_0) may always not include the field indicating transform precoding state regardless of the configuration information. For example, even if the configuration information indicates that the field exists, the fallback DCI may not include the field. The transform precoding state for a fallback DCI may be a default transform precoding state as stated above.

In some other embodiments of the present application, the first indication information may include a DCI. In such embodiments, the BS may transmit configuration information indicating a set of elements, each element is associated with one or more transform precoding states, and the DCI indicates one of the set of elements.

In an embodiment, the DCI may include a field indicating one of the set of elements. The number of bits of the field depends on the number of elements in the set of elements, for example, the number of bits may be equal to log₂^{N}, wherein N is the number of elements in the set of elements. In some cases, each element may be associated with one or two transform precoding states (e.g., corresponding to one or two UL waveforms which are from CP-OFDM and DFT-s-OFDM waveforms). The specific examples for elements may be referred to as Table 1 as stated above.

In the cast that the field indicates two transform precoding states (hereinafter, transform precoding state #1′ and transform precoding state #2′), the two transform precoding states may be applied to a number of repetitions of the PUSCH transmission. For example, in the case that the second row in Table 1 is indicated, transform precoding state #1′ may refer to the disabled state, and transform precoding state #2′ may refer to the enable state. The number of repetitions may be a number of PUSCH Type A repetitions as specified in 3GPP standard documents or may be a number of PUSCH Type B repetitions as specified in 3GPP standard documents.

In the case that a number of repetitions of the PUSCH transmission is two, transform precoding state #1′ is indicated to be applied to the first repetition and transform precoding state #2′ is indicated to be applied to the second repetition.

In the case that the number of repetitions of the PUSCH transmission is larger than two and cyclic mapping is enabled (e.g., “PUSCH-Config” may include a parameter “cyclicMapping OF WF” indicating that the mapping type of a waveform is cyclic mapping), the BS may determine that transform precoding state #1′ and transform precoding state #2′ are indicated to be applied to the number of repetitions alternatively. For example, transform precoding state #1′ and transform precoding state #2′ are indicated to be applied to the first repetition and the second repetition of the number of repetitions respectively, and the same mapping pattern continues to the remaining repetitions of the number of repetitions (if any).

In the case that a number of repetitions of the PUSCH transmission is larger than two and sequential mapping is enabled (e.g., “PUSCH-Config” may include a parameter “sequentialMapping OF WF” indicating that the mapping type of a waveform is sequential mapping), the BS may determine that transform precoding state #1′ and transform precoding state #2′ are indicated to be applied to every two repetitions of the number of repetitions alternatively. For example, transform precoding state #1′ is indicated to be applied to the first repetition and the second repetition of the number of repetitions, and state of transform precoding #2 is indicated to be applied to the third repetition and the fourth repetition of the number of repetitions, and the same mapping pattern continues to the remaining repetitions of the number of repetitions (if any).

In some other embodiments of the present application, the first indication information may include a DCI. In such embodiments, the BS may transmit a table to the UE via higher layer signaling (e.g., RRC signaling) or the table may be pre-defined (e.g., fixed in 3GPP standard documents). The table may include one or more rows (i.e., entries). Each row may indicate at least one of: a slot offset (e.g., K2 as specified in 3GPP standard documents); a SLIV or a start symbol and an allocation length; a PUSCH mapping type (e.g., PUSCH mapping type A and/or PUSCH mapping type B as specified in 3GPP standard documents); a transform precoding state for a PUSCH transmission; or a number of repetitions to be applied to a PUSCH transmission. For example, a row may include a parameter indicating the transform precoding state.

In such embodiments, the DCI may include a TDRA field which indicates a row of the table. For example, the TDRA field with a value “m” may indicate a row index “m+1” of the table. The row indicated by the TDRA fields may indicate the transform precoding state.

The specific examples of the table may be referred to Table 2 and Table 3 as stated above.

In some cases, one or more rows of the table may not indicate the transform precoding state, which may suggest that the corresponding transform precoding state is a default transform precoding state as stated above.

In some cases, a row of the table may indicate a number of repetitions of the PUSCH transmission. In such cases, a TDRA field of the DCI may indicate a corresponding row of the table. For example, the TDRA field with a value “m” may indicate a row index “m+1” of the table. Consequently, the row indicated by the may indicate the number of repetitions.

Whether the transform precoding state is enabled or disabled may be based on the indicated the number of repetitions and a threshold. For example, in the case that the number of repetitions is larger than the threshold, transform precoding state #A1′ is indicated to be applied to the PUSCH transmission; in the case that the number of repetitions is smaller than or equal to the threshold, second transform precoding state #A2′ is indicated to be applied to the PUSCH transmission. The BS may transmit the threshold via higher layer signaling) or the threshold may be pre-defined (e.g., fixed in 3GPP standard documents). In an embodiment of the present application, transform precoding state #A1′ may be that the enabled state (i.e., the transform precoding is enabled, which may indicate that a DFT-S-OFDM waveform is to be applied to); and transform precoding state #A2′ may be the disabled state (i.e., the transform precoding is disabled, which may indicate that a CP-OFDM waveform is to be applied.

In some other embodiments of the present application, the first indication information may include a DCI including a FDRA field. A first value of the FDRA field may indicate a first resource allocation type and a second value of the FDRA field may indicate a second resource allocation type. In such embodiments, in the case that the first resource allocation type is indicated, the transform precoding is disabled; in the case that the second resource allocation type is indicated, the transform precoding is enabled. For example, the first value may be “0” and the second value may be “1”, and the first resource allocation type may be resource allocation type 0 as specified in 3GPP standard documents and the second resource allocation type may be resource allocation type 1 as specified in 3GPP standard documents.

For example, a plurality of uplink resource allocation schemes (e.g., type 0, type 1 and type 2) may be supported. In the case that the parameter resourceAllocation as specified in 3GPP standard documents is configured as ‘dynamicSwitch’, a certain bit (e.g., the most significant bit (MSB)) of the FDRA field may be used to indicate resource allocation type 0 or resource allocation type 1. For example, the value of the MSB being “0” may indicate resource allocation type 0 and the value of the MSB being “1” may indicate resource allocation type 1. In the case that the resource allocation type 0 is indicated, the CP-OFDM waveform (e.g., the transform precoding is disabled) may be used for a PUSCH transmission; in the case that the resource allocation type 1 is indicated, a DFT-s-OFDM waveform (e.g., the transform precoding is enabled) may be used for a PUSCH transmission.

In some other embodiments of the present application, the first indication information may include a DCI. In such embodiments, the BS may transmit configuration information indicating an association between a SRS resource set and a transform precoding state (e.g., disabled or enabled state). For example, the configuration information may indicate that a first SRS resource set is associated with transform precoding state #B1′ and a second SRS resource set is associated with second transform precoding state #B2′. Transform precoding states #B1 and #B2 may be the disabled state and enabled state, respectively; or vice versa. The DCI may include a SRS resource indicator which indicates at least one SRS resource set for the PUSCH transmission. The transform precoding state to be applied can be determined based on the SRS resource indicator and the configuration information.

In some examples, the number of repetitions of the PUSCH transmission may be larger than one. A first value (e.g., “00”) of the SRS resource indicator may indicate the first SRS resource set and the associated transform precoding state (e.g., transform precoding state #B1′) may be indicated to be applied to all of the number of repetitions.

In some examples, the number of repetitions of the PUSCH transmission may be larger than one. A second value (e.g., “01”) of the SRS resource indicator may indicate the second SRS resource set and the associated transform precoding state (e.g., transform precoding state #B2′) may be indicated to be applied to all of the number of repetitions.

In some examples, a third value (e.g., “10”) of the SRS resource indicator may indicate the first SRS resource set and the second SRS resource set, and the associated transform precoding states (e.g., transform precoding state #B1′ and transform precoding state #B2′) may be indicated to be applied to the number of repetitions according to the following methods:
In the case that the number of repetitions of the PUSCH transmission is two, transform precoding state #B1′ is indicated to be applied to the first repetition of the number of repetitions and transform precoding state #B2′ is indicated to be applied to the second repetition of the number of repetitions.
In the case that the number of repetitions of the PUSCH transmission is larger than two and cyclic mapping is enabled (e.g., “PUSCH-Config” may include a parameter “cyclicMapping” indicating that the mapping type of a waveform is cyclic mapping), the UE may determine that transform precoding state #B1′ and transform precoding state #B2′ are indicated to be applied to the number of repetitions alternatively. For example, transform precoding states #B1 and #B2 are indicated to be applied to the first repetition and the second repetition of the number of repetitions respectively, and the same mapping pattern continues for the remaining repetitions of the number of repetitions (if any). In such cases, the same mapping pattern may refer to that transform precoding state #B1′ is indicated to be firstly applied to a repetition and transform precoding state #B2′ is indicated to be applied to a following repetition. For example, transform precoding states #B1 and #B2 are indicated to be applied to the third repetition and the fourth repetition of the number of repetitions, respectively.
In the case that the number of repetitions of the PUSCH transmission is larger than two and a sequential mapping is enabled (e.g., “PUSCH-Config” may include a parameter “sequentialMapping” indicating that the mapping type of a waveform is sequential mapping), the UE may determine that transform precoding states #B1 and #B2 are indicated to be applied to every two repetitions of the number of repetitions alternatively. For example, transform precoding state #B1′ is indicated to be applied to the first repetition and the second repetition of the number of repetitions, and transform precoding state #B2′ is indicated to be applied to the third repetition and the fourth repetition of the number of repetitions, and the same mapping pattern continues to the remaining repetitions of the number of repetitions (if any). In such cases, the same mapping pattern may refer to that transform precoding state #B1′ is indicated to be firstly applied to two repetitions and transform precoding state #B2′ is indicated to be applied to the following two repetitions. For example, transform precoding state #B1′ is indicated to be applied to the fifth repetition and the sixth repetition of the number of repetitions, and transform precoding state #B2′ is indicated to be applied to the seventh repetition and the eighth repetition of the number of repetitions.

In some examples, a fourth value (e.g., “11”) of the SRS resource indicator may indicate the second SRS resource set and the first SRS resource set, and the associated transform precoding states (e.g., transform precoding state #B2′ and transform precoding state #B1′) may be indicated to be applied to the number of repetitions according to the following methods:
In the case that a number of repetitions of the PUSCH transmission is two, transform precoding state #B2′ is indicated to be applied to the first repetition of the number of repetitions and transform precoding state #B1′ is indicated to be applied to the second repetition of the number of repetitions.
In the case that the number of repetitions of the PUSCH transmission is larger than two and cyclic mapping is enabled (e.g., “PUSCH-Config” may include a parameter “cyclicMapping” indicating that the mapping type of a waveform is cyclic mapping), the UE may determine that transform precoding state #B2′ and transform precoding state #B1′ are indicated to be applied to the number of repetitions alternatively. For example, transform precoding states #B2 and #B1 are indicated to be applied to the first repetition and the second repetition of the number of repetitions respectively, and the same mapping pattern continues for the remaining repetitions of the number of repetitions (if any). In such cases, the same mapping pattern may refer to that transform precoding state #B2′ is indicated to be firstly applied to a repetition and transform precoding state #B1′ is indicated to be applied to a following repetition. For example, transform precoding states #B2 and #B1 are indicated to be applied to the third repetition and the fourth repetition of the number of repetitions respectively.
In the case that a number of repetitions of the PUSCH transmission is larger than two and a sequential mapping is enabled (e.g., “PUSCH-Config” may include a parameter “sequentialMapping” indicating that the mapping type of a waveform is sequential mapping), the UE may determine that transform precoding states #B2 and #B1 are indicated to be applied to every two repetitions of the number of repetitions alternatively. For example, transform precoding state #B2′ is indicated to be applied to the first repetition and the second repetition of the number of repetitions, and transform precoding state #B1′ is indicated to be applied to the third repetition and the fourth repetition of the number of repetitions, and the same mapping pattern continues to the remaining repetitions of the number of repetitions (if any). In such cases, the same mapping pattern may refer to that transform precoding state #B2′ is indicated to be firstly applied to two repetitions and transform precoding state #B1′ is indicated to be applied to the following two repetitions. For example, transform precoding state #B2′ is indicated to be applied to the fifth repetition and the sixth repetition of the number of repetitions, and transform precoding state #B1′ is indicated to be applied to the seventh repetition and the eighth repetition of the number of repetitions.

The number of repetitions may be a number of PUSCH Type A repetitions as specified in 3GPP standard documents or may be a number of PUSCH Type B repetitions as specified in 3GPP standard documents.

In some other embodiments of the present application, the first indication information may include a DCI. The transform precoding state may be indicated by the DCI format of the DCI.

For example, in the case that the DCI format of the DCI is a fallback DCI format (e.g., DCI format 0_0), the transform precoding state may be a default transform precoding state as stated above.

In another example, the BS may transmit configuration information indicating an association between a DCI format and a transform precoding state to the UE. For example, the BS may configure that DCI format 0_1 is associated with transform precoding state #C1′ and DCI format 0_2 is associated with transform precoding state #C2′.

In yet another example, the association between a DCI format and a transform precoding state may be pre-defined (e.g., fixed in 3GPP standard documents).

In some other embodiments of the present application, the first indication information may include a DCI. The transform precoding state may be indicated by a search space set, a CORESET, or a BWP in which the DCI is transmitted.

In an embodiment, the BS may transmit configuration information indicating an association between the SSS, the CORESET, or the BWP in which the DCI is transmitted and a transform precoding state to the UE.

In another embodiment, the association between the SSS, the CORESET, or the BWP in which the DCI is transmitted and a transform precoding state may be pre-defined (e.g., fixed in 3GPP standard documents).

In some other embodiments of the present application, the first indication information may include a DCI, and a CRC of the DCI is scrambled by a RNTI. In such embodiments, the transform precoding state may be indicated by the RNTI. In an embodiment of the present application, the RNTI for scrambling CRC of the DCI is an RNTI specific for transform precoding state switch.

In some other embodiments of the present application, the first indication information may include a medium access control (MAC) control element (CE). In some embodiments, the MAC CE may indicate whether the transform precoding is enabled or not directly, or indicate that the transform precoding state is switched from one of an enabled state and a disabled state to the other state of the enabled state and disabled state, or indicate that the transform precoding state is switched from a last applied state to another state, or indicate that the transform precoding state is switched from a default transform precoding state to another state.

The above embodiments in step 701 may be used to determine a transform precoding state for a PUSCH transmission. Various other methods can also be applied to determine the transform precoding state.

In step 703, the BS may determine whether the transform precoding state is applied to a first PUSCH transmission. That is, in step 703, the BS may determine when to realize the transform precoding state, in other words, when the transform precoding state takes effect.

According to some embodiments of the present application, the BS may determine whether the transform precoding state is applied based on a number of time units between a time unit (time unit #1′) associated with the first indication information and another time unit (time unit #2′) associated with the first PUSCH transmission. The time unit may be one of: a frame, a subframe, a slot, a sub-slot, a mini-slot, a symbol, etc. Time unit #1′ may be a time unit in which the first indication information is transmitted, or a start time unit for transmitting the first indication information, or an end time unit for transmitting the first indication information, or a time unit in which feedback signaling (e.g., ACK or NACK) for the first indication information is received by the BS. Time unit #2′ may be a time unit in which the first PUSCH transmission is received, or a start time unit for receiving the first PUSCH transmission, or an end time unit for receiving the first PUSCH transmission.

The number of time units may be compared with a timing parameter (e.g., (e.g., N time units) to determine whether the transform precoding state is applied to the first PUSCH transmission.

In some embodiments, the BS may receive the timing parameter from the UE. In some other embodiments, the timing parameter may be pre-defined (e.g., fixed in 3GPP standard documents). The BS can utilize the timing parameter to optimize the scheduling scheme.

For example, in the case that the number of time units is smaller than a timing parameter (e.g., N time units) for transform precoding state switching, the BS may determine the transform precoding state is not applied to the first PUSCH transmission. In such example, the BS may determine that the default transform precoding state as stated above or the last applied transform precoding state is applied for the first PUSCH transmission. In the case that the number of time units is larger than or equal to the timing parameter, the BS may determine that the transform precoding state is applied to the first PUSCH transmission.

According to some embodiments of the present application, the BS may determine that the transform precoding state is applied in response to transmitting the first indication information. For example, the transform precoding state takes effect immediately once it is transmitted, i.e., which may be equivalent to “NO” in the above embodiments.

The PUSCH transmission (e.g., the first PUSCH transmission as described above) in the context of the present disclosure may be one of: a CG type 1 based PUSCH transmission; a CG type 2 based PUSCH transmission; a PUSCH transmission scheduled by a fallback DCI; or a PUSCH transmission scheduled by a DCI which is not configured with transform precoding state switch. For example, the DCI which is not configured with transform precoding state switch may include: the configuration information indicates that a field indicating the transform precoding state does not exist in the DCI or a DCI format which does not support the transform precoding state switch, etc.

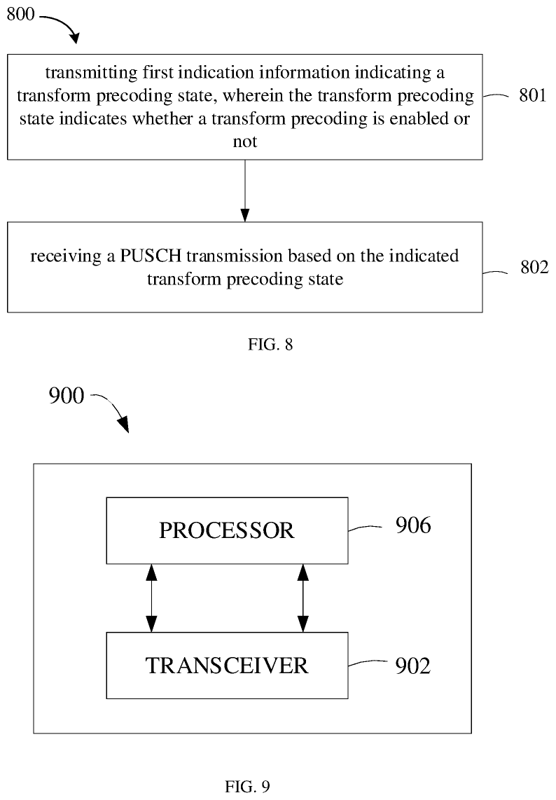

FIG. 8 is a flow chart illustrating an exemplary method 800 for transform precoding state switching according to some embodiments of the present application. The method in FIG. 8 may be implemented by a BS (e.g., BS 102 as shown in FIG. 1). Details described in all of the foregoing embodiments of the present disclosure are applicable for the embodiments shown in FIG. 8.

In the exemplary method shown in FIG. 8, in step 801, the BS may transmit first indication information indicating a transform precoding state to a UE (e.g., UE 101 as shown in FIG. 1). All the embodiments in step 701 may also be applied for step 801. After transmitting the first indication information, in step 803, the BS may receive a PUSCH transmission (PUSCH transmission #E1′) based on the indicated transform precoding state (transform precoding state #E1′).

In some embodiments of the present application, the first indication information may include a DCI and PUSCH transmission #E1′ may be a PUSCH transmission scheduled by the DCI.

In some embodiments of the present application, the number of time units between the time unit associated with the first indication information and the time unit associated with PUSCH transmission #E1′ is larger than or equal to a timing parameter. The descriptions regarding the time unit(s) and timing parameter with respect to FIG. 7 may also apply here. In some embodiments of the present application, PUSCH transmission #E1′ may not be the PUSCH transmission scheduled by the DCI.

After transform precoding state #E1′ takes effect on the PUSCH transmission #E1′ (which may be determined based on the methods described with respect to FIG. 7 or other methods), the BS may determine how the transform precoding state #E1′ is held on.

In some embodiments of the present application, the transform precoding state #E1′ takes effect only once. That is, the BS may determine that the transform precoding state #E1′ is not applied to a PUSCH transmission after the transform precoding state #E1′. In some embodiments, the PUSCH transmission after PUSCH transmission #E1′ may use a default transform precoding state as stated above.

In some other embodiments of the present application, the transform precoding state #E1′ may take effect until another indication information (referred to as “second indication information” for clarity) indicating a transform precoding state different from transform precoding state #E1′ is received.

For example, referring to case 1 in FIG. 5, the BS may transmit second indication information indicating a different transform precoding state after the first indication information but before PUSCH transmission 501. The BS may determine that the transform precoding state #E1′ is not applied to PUSCH transmission 501.

Referring to case 2 in FIG. 5, the BS may transmit second indication information indicating a different transform precoding state after the first indication information. The BS may receive PUSCH transmission 502 before the second indication information, the BS may determine that the transform precoding state #E1′ is applied to PUSCH transmission 502.

Referring to case 3 in FIG. 5, the BS may transmit second indication information indicating a different transform precoding state after the first indication information. The number of time units between the time unit associated with the second indication information and the time unit associated with PUSCH transmission 503 is larger than or equal to a timing parameter (e.g., N time units), the BS may determine that transform precoding state #E1′ is not applied to PUSCH transmission 503. The BS may determine that the transform precoding state indicated by the second indication information is to be applied to PUSCH transmission 503.

Referring to case 4 in FIG. 5, the BS may transmit second indication information indicating a different transform precoding state after the first indication information. The number of time units between the time unit associated with the second indication information and the time unit associated with PUSCH transmission 504 is smaller than the timing parameter. The BS may determine that transform precoding state #E1′ is applied to PUSCH transmission 504.

In some other embodiments, the first transform precoding state may take effect during a certain time. For example, the BS may start a timer in response to the first indication information. The BS may transmit the value of the timer to the UE or the value of the timer may be pre-defined (e.g., fixed in 3GPP standard documents). In some embodiments, the value of the timer includes a number of time units. In an embodiment, the time unit is one of: a frame, a subframe, a slot, a sub-slot, a mini-slot, a symbol, etc.

The descriptions regarding the timer in the previous text may apply here.

For example, all PUSCH transmissions during the timer (i.e., when the timer is running) may use transform precoding state #E1′. For example, the BS may determine whether the transform precoding state #E1′ is applied to a PUSCH transmission (PUSCH transmission #E2′) after PUSCH transmission #E1′ or not. Specifically, the BS may determine that transform precoding state #E1′ is applied to PUSCH transmission #E2′ when the timer is running; and determine that the transform precoding state #E1′ is not applied to PUSCH transmission #E2′ when the timer expires. In some embodiments, the BS may determine that a default transform precoding state or a transform precoding state applied before transform precoding state #E1′ is applied to PUSCH transmission #E2′ after the timer expires.

In some embodiments, the BS may not transmit indication information to indicate the transform precoding state switching during the timer.

In some other embodiments, the BS may transmit indication information to indicate a transform precoding state (transform precoding state #E3′) during the timer. In an embodiment, transform precoding state #E3′ may be the same as transform precoding state #E1′. In another embodiment, transform precoding state #E3′ transform is different from transform precoding state #E1′. However, the BS may determine that the different transform precoding state #E3′ is not applied; or the BS may determine that transform precoding state #E3′ is not applied during the timer and is applied to a PUSCH transmission in response to the expiry of the timer (in other words, after the timer expires).

In some embodiments of the present application, the timer may be used under some condition. For example, the BS may start the timer (i.e., the timer is used) when the first indication information indicates that the transform precoding is switched from an enabled state (e.g., DFT-s-OFDM waveform) to a disabled state (e.g., CP-OFDM waveform).

In another example, the BS may start the timer (i.e., the timer is used) when the first indication information indicates that the transform precoding is switched from a disabled state (e.g., CP-OFDM waveform) to an enabled state (e.g., DFT-s-OFDM waveform).

In yet another embodiment, the BS may transmit configuration information indicating the condition to start the timer. The condition may include: the timer is started (i.e., the timer is used) when the first indication information indicates that the transform precoding is switched from one of the enabled state and disabled state to the other of the enabled state and disabled state. For example, the configuration information may indicate that the timer is started when the first indication information indicates that the transform precoding is switched from a disabled state to an enabled state.

According to some embodiments of the present application, the BS may receive an indication of whether the UE supports transform precoding state switching or not. According to some embodiments of the present application, the BS may transmit configuration information indicating whether the UE is allowed to perform transform precoding state switching. In some embodiments, in the case that a UE is allowed to perform transform precoding state switching, the BS may use the embodiments in FIG. 7 and FIG. 8 to determine the transform precoding state for a PUSCH transmission associated with the UE.

FIG. 9 illustrates a block diagram of an exemplary apparatus 900 according to some embodiments of the present disclosure. As shown in FIG. 9, the apparatus 900 may include at least one processor 906 and at least one transceiver 902 coupled to the processor 906. The apparatus 900 may be a UE or a BS. Details described in all of the foregoing embodiments of the present disclosure are applicable for the embodiments shown in FIG. 9.

Although in this figure, elements such as the at least one transceiver 902 and processor 906 are described in the singular, the plural is contemplated unless a limitation to the singular is explicitly stated. In some embodiments of the present application, the transceiver 902 may be divided into two devices, such as a receiving circuitry and a transmitting circuitry. In some embodiments of the present application, the apparatus 900 may further include an input device, a memory, and/or other components.

In some embodiments of the present application, the apparatus 900 may be a UE. The transceiver 902 and the processor 906 may interact with each other so as to perform the operations with respect to the UE described in FIGS. 2-6. In some embodiments of the present application, the apparatus 900 may be a BS. The transceiver 902 and the processor 906 may interact with each other so as to perform the operations with respect to the BS described in FIGS. 7 and 8.

In some embodiments of the present application, the apparatus 900 may further include at least one non-transitory computer-readable medium.

For example, in some embodiments of the present disclosure, the non-transitory computer-readable medium may have stored thereon computer-executable instructions to cause the processor 906 to implement the method with respect to the UE as described above. For example, the computer-executable instructions, when executed, cause the processor 906 interacting with transceiver 902 to perform the operations with respect to the UE described in FIGS. 2-6.

In some embodiments of the present disclosure, the non-transitory computer-readable medium may have stored thereon computer-executable instructions to cause the processor 906 to implement the method with respect to the BS as described above. For example, the computer-executable instructions, when executed, cause the processor 906 interacting with transceiver 902 to perform the operations with respect to the BS described in FIGS. 7 and 8.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes.” “including.” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE) for wireless communication, comprising:
at least one memory; and
at least one processor coupled with the at least one memory and configured to cause the UE to:
receive first indication information indicating a transform precoding state for a physical uplink shared channel (PUSCH) transmission, wherein the transform precoding state indicates whether a transform precoding is enabled or not; and
determine whether to apply the transform precoding state to a first PUSCH transmission.

2. The UE of claim 1, wherein the first indication information comprises downlink control information (DCI), and the at least one processor is further configured to cause the UE to receive configuration information indicating whether a field for indicating the transform precoding state exists or not in the DCI.

3. The UE of claim 2, wherein the configuration information is configured per UE or per DCI format.

4. The UE of claim 1, wherein the first indication information comprises a downlink control information (DCI), and the DCI includes a time domain resource allocation (TDRA) field, which indicates a row in a table, wherein the row indicates at least one of:
a slot offset;
a start and length indicator (SLIV), or a start symbol and an allocation length;
a PUSCH mapping type;
the transform precoding state for the PUSCH transmission; or
a number of repetitions to be applied to the PUSCH transmission.

5. (canceled)

6. The UE of claim 1, wherein, to determine whether to apply the transform precoding state comprises the at least one processor is configured to cause the UE to determine whether to apply the transform precoding state based on a number of time units between a first time unit associated with the first indication information and a second time unit associated with the first PUSCH transmission.

7. (canceled)

8. The UE of claim 1, wherein the at least one processor is further configured to cause the UE to at least one of:
report whether the UE supports a transform precoding state switch or not; or
receive configuration information indicating whether the UE is allowed to perform the transform precoding state switch.

9. A user equipment (UE) for wireless communication, comprising:
at least one memory; and
at least one processor coupled with the at least one memory and configured to cause the UE to:
receive first indication information indicating a first transform precoding state, wherein the first transform precoding state indicates whether a transform precoding is enabled or not; and
transmit a first physical uplink shared channel (PUSCH) transmission based on the first transform precoding state.

10. The UE of claim 9, wherein the first transform precoding state is not applied to a second PUSCH transmission after the first PUSCH transmission.

11. The UE of claim 9, wherein the at least one processor is further configured to determine whether the first transform precoding is applied to a second PUSCH transmission after the first PUSCH transmission or not.

12. The UE of claim 11, wherein, to determine whether the first transform precoding is applied to the second PUSCH transmission includes:
if a second indication information indicates a second transform precoding state is received after the first indication information but before the second PUSCH transmission, the first transform precoding is not applied to the second PUSCH transmission; otherwise, the first indication information is applied to the second PUSCH transmission; or
if the second indication information indicates the second transform precoding state is received after the first indication information and a number of time units between a first time unit associated with the second indication information and a second time unit associated with the second PUSCH transmission is larger than or equal to a timing parameter, the first transform precoding is not applied to the second PUSCH transmission; otherwise, the first transform precoding is applied to the second PUSCH transmission.

13. The UE of claim 11, wherein, to determine whether the first transform precoding state is applied to the second PUSCH transmission includes the at least one processor configured to cause the UE to:
start a timer in response to receiving the first indication information;
determine that the first transform precoding state is applied to the second PUSCH transmission when the timer is running; and
determine that the first transform precoding state is not applied to the second PUSCH transmission when the timer expires.

14. The UE of claim 13, wherein the at least one processor is configured to cause the UE to apply a default transform precoding state or a transform precoding state applied before the first transform precoding state to the second PUSCH transmission after the timer expires.

15. A base station (BS) for wireless communication, comprising:
at least one memory; and
at least one processor coupled with the at least one memory and configured to cause the BS to:
transmit, to a user equipment (UE), first indication information indicating a transform precoding state for a physical uplink shared channel (PUSCH) transmission, wherein the transform precoding state indicates whether a transform precoding is enabled or not; and
determine whether the transform precoding state is applied to a first PUSCH transmission.

16. The UE of claim 9, wherein the first indication information comprises downlink control information (DCI), and the at least one processor is configured to cause the UE to receive configuration information indicating whether a field for indicating the transform precoding state exists or not in the DCI.

17. The UE of claim 16, wherein the configuration information is configured per DCI format.

18. The UE of claim 16, wherein, if the configuration information indicates that the field does not exist, the DCI does not include the field indicating the transform precoding state, and the transform precoding state is a default transform precoding state.

19. A processor for wireless communication, comprising:
at least one controller coupled with at least one memory and configured to cause the processor to:
receive first indication information indicating a first transform precoding state, wherein the first transform precoding state indicates whether a transform precoding is enabled or not; and
transmit a first physical uplink shared channel (PUSCH) transmission based on the first transform precoding state.

20. The processor of claim 19, wherein the first indication information comprises downlink control information (DCI), and the at least one controller is configured to cause the processor to receive configuration information indicating whether a field for indicating the transform precoding state exists or not in the DCI.

21. The processor of claim 20, wherein the configuration information is configured per DCI format.

22. The processor of claim 20, wherein, if the configuration information indicates that the field does not exist, the DCI does not include the field indicating the transform precoding state, and the transform precoding state is a default transform precoding state.
